(19) United States
(12) Patent Application Publication
(10) Pub. No.: US 2021/0236915 A1
(43) Pub. Date: Aug. 5, 2021

(54) ELECTRONIC GAME SYSTEM WITH ROLE-PLAY AUGMENTED REALITY AND SIGNAL ACTIVATION WATER RELEASE

(71) Applicant: Elliot A. Rudell, Franklin, TN (US)

(72) Inventor: Elliot A. Rudell, Franklin, TN (US)

(21) Appl. No.: 17/202,450

(22) Filed: Mar. 16, 2021

Related U.S. Application Data
(63) Continuation-in-part of application No. 16/680,420, filed on Nov. 11, 2019, now Pat. No. 10,950,059.
Application No. 16/680,420 is a continuation-in-part of application No. 15/724,734, filed on Oct. 4, 2017, now Pat. No. 10,471,340.
(60) Provisional application No. 62/404,004, filed on Oct. 4, 2016.
(60) Provisional application No. 62/916,084, filed on Oct. 16, 2019.

(51) Int. Cl. A63F 9/02; F41J 5/02; G06T 19/00; F41B 9/00; A63F 9/24

(52) U.S. Cl. CPC A63F 9/0278; F41J 5/02; G06T 19/006; A63F 9/0204; A63F 2250/0428; A63F 9/24; A63F 2009/2447; A63F 2250/497; F41B 9/00

(57) ABSTRACT

The present application describes liquid release of fluid, preferably water, onto the head or heads of a player or players of an electronic interactive game, which may incorporate virtual reality, mixed reality or augmented reality. In most embodiments, the gameset includes headgear that includes a liquid reservoir for dispensing a liquid on a player. The gameset may include toy “weapons” to simulate play-combat between players, wherein movements or impacts sensed by said weapons can send wireless signals to activate the release of water onto the head or heads of players. The gameset may also include an electronic display to visually present imagery to the player, and a receiver that transmits a signal to a receiver coupled to the headgear to dispense liquid from the liquid reservoir onto a player.

### CROSS REFERENCE TO RELATED APPLICATION

This patent application is a continuation-in-part of U.S. patent application Ser. No. 16/680,420, filed Nov. 11, 2019, entitled “SIGNAL ACTIVATED LIQUID RELEASE FOR VIRTUAL, MIXED AND AUGMENTED REALITY” and scheduled to issue as U.S. Pat. No. 10,950,059, which is a continuation-in-part of U.S. patent application Ser. No. 15/724,734 (now U.S. Pat. No. 10,471,340), entitled “Signal Beam Activated Water Release Game” and filed Oct. 4, 2017, which claims the benefit under 35 USC 119 of U.S. Provisional Patent Application Ser. No. 62/404,004, entitled “Signal Beam Activated Water Release Game”, filed Oct. 4, 2016. This patent application also claims the benefit under 35 USC 119 of U.S. Provisional Patent Application Ser. No. 62/916,084, entitled “SIGNAL ACTIVATED LIQUID RELEASE FOR VIRTUAL AND AUGMENTED REALITY GAMING,” filed Oct. 16, 2019. The contents of all of the aforementioned are incorporated herein by reference in their entirety.

### FIELD OF THE INVENTION

The invention of the present application is directed towards water toys and water gaming activities.

### BACKGROUND INFORMATION

Children and young adults enjoy engaging playing what is referred to as “role playing” activity, which can be described as play wherein participants pretend to be acting, competing or combating like superheroes, warriors, first responders, etc. The play props and elements often associated with such role playing can include costumes including capes and armor, shields, helmets, bracelets, belts, play swords, play spears, play cudgels, play hatchets, play “gun” blasters that can shoot foam projectiles, and also simulated tools such as fire buckets, make-believe air horns, etc.

Many role play toys include electronic and electronic-mechanical components to provide for realistic simulation of combat sounds and lights. A nearly $300 collectible Luke Skywalker (STAR WARS) helmet includes internal speakers and lighting effects coordinated to simulate the “blasts of enemy vehicles”.

A plastic-molded arm and glove unit called “Avengers EndGame Fist” provides sounds and lights to increase the play-experience of the child as they wear the electronic role play toy on their hand and arm and make-believe they are the superhero Thor.

The WETHEAD play pattern that amassed nearly 300,000,000-350,000,000 YOUTUBE views from third party posted videos involved players playing games and removing plastic rods from a plastic helmet, eventually removing the one rod that would release water onto the head of the wearer of the helmet.

U.S. Pat. No. 10,471,340 is exemplified by such allowed claims as:
1. A gameset configured to emit a liquid onto a player comprising: a hat configured to be worn on a head of a player and comprising a receiver, a liquid reservoir configured to hold a liquid, and a valve controlled by a solenoid or by a motor; a remote device comprising a transmitter configured to transmit a wireless signal to the receiver; and one or more power sources configured to power the transmitter and the receiver, wherein, upon reception of the wireless signal from the transmitter, the receiver is configured to automatically cause the valve to open and dispense the liquid from the liquid reservoir downward onto the player's head, said dispensing aided and not hindered by gravity.
10. A method of play comprising the steps of: a) providing the gameset of claim 1; b) placing the hat on a player's head; c) transmitting a wireless signal from the transmitter to the receiver; and d) dispensing liquid from the liquid reservoir onto the player's head in response to the receiver receiving the wireless signal from the transmitter.

U.S. Pat. No. 10,950,059 is exemplified by allowed claims such as
1. A gameset configured to emit a liquid onto a player comprising:
headgear configured to be worn on a head of a player and comprising
a liquid reservoir configured to hold a liquid and a valve controlled by a solenoid or by a motor;
a receiver coupled to the headgear;
an electronic display screen to display imagery to said player;
a transmitter to transmit a signal to the receiver; and
one or more power sources configured to power the transmitter, the electronic display screen and the receiver,
wherein, upon reception of the signal from the transmitter, the receiver is configured to activate dispensing of liquid from the liquid reservoir onto the player.

It is the purpose and intent of this application to disclose the activity of players participating in role play, wearing electronically equipped helmets similar to as described in said '340 patent, and as an alternative to sending a wireless signal from a compatibly equipped blaster gun or from a computer or game system unit, the players of the gaming invention of this application are uniquely engaging in physical “play combat”, competing and wielding, or even throwing, safe toylike “weapons” such as spears or swords, etc. and either the movements of such toylike weapons (electronically detected by an internal accelerometer or other motion detector component) in each, or the electronically-detected impact of one such toylike weapon as it physically touches a similar toylike weapon or a toy shield of the game system or even senses safe impact as such toylike weapon touches another player, initiates the sending of a wireless signal to a receiver in the electronic helmet of their opponent (player #2) and the receipt of said signal activates the release of water onto the head of player #2. It is desired and assumed that all of the components of this electronic gaming system are primarily plastic or foam construction, and therefore safe. Such safety being achieved with role-play combat, battling, dueling, while players might be dressed-up like warriors and superheroes with weapons, is an established, confirmed, and multi-million dollar category of the toy industry. www.amazon.com/s?k=role+play+weapons&ref=nb_sb_noss_2.

Furthermore and to increase the play enjoyment of the gaming system described in this application, the inclusion of the image display technology as described in U.S. Pat. No. 10,950,059 can also be employed so that players of the gaming system can also be presented with electronic images of either actual competitors participating in the gaming activity, or with images of “avatars” of said players, so that all players can try to manipulate and wield their toy play weapons in such a manner as to activate signal-sending to confirm their correct or incorrect “battle moves” so as to initiate water (or similar liquid) release from a headset of the invention worn by either themselves or by an opponent.

In the embodiment of toylike weapons sending an electronic signal as the result of said weapon being successfully manipulated by a user in one of several pre-programmed specific movements (such as, for example, a counter-rotating arc movement), it is unnecessary for such weapon to be in actual physical contact with any other toylike weapon or to come into physical contact with another player or opponent, because the electronic signal transmitted by said first toylike weapon can be wirelessly transmitted via Bluetooth or infrared or radio control or similar signal and then received by the game components of a second (or multiple other) player or players even located in remote locations, so that one player's physical actions and movement of a wireless signal sending toylike weapon can result in other combatants receiving wireless signals to activate water release onto the heads of said other combatants located even in remote locations anywhere on earth. Alternatively, a player failing to maneuver or manipulate their own weapon in a preprogrammed fashion could even send a signal to that same player's own helmet, and activate water release onto their own head as a play-penalty. Also, alternatively and as briefly described in this application, a toy such as a projectile or a play sword or spear, without any electronics onboard, could be thrown or otherwise moved into contact with a target area simulating, for example, a dartboard. When a sensor in said target area detected impact, that “dartboard” or similar recipient toy could send a wireless signal to a compatible headset of the game system, and a player wearing that headset could get wet as a result of water being electronically released onto their head, as described later in this application.

### SUMMARY OF THE INVENTION

This is a continuation-in-part application pertaining to an issued patent and allowed application wherein is described a system whereby a head-worn invention contains a water or other liquid container and then releases the water or other liquid onto the head of a wearer of the invention when a valve is opened.

In some embodiments, as shown in new FIGS. 24-33, the present disclosure provides: a gameset configured to emit a liquid onto a player that includes one or more of the following features: headgear configured to be worn on a head of a player and comprising a liquid reservoir configured to hold a liquid; a receiver coupled to the headgear; at least one of a motion sensor (such as an accelerometer or other motion sensor) or an impact sensor, and a transmitter to transmit a signal to the receiver upon reception of a signal from the motion sensor or the impact sensor; and/or one or more power sources configured to power the transmitter, the motion sensor or the impact sensor and the receiver. Optionally, upon reception of the signal from the transmitter, the receiver is configured to activate dispensing of liquid from the liquid reservoir onto the player. Optionally, the gameset comprises a toy weapon or wearable comprising the motion sensor or impact sensor. Optionally, the wearable is a clothing item or clothing accessory (e.g., bracelet, cape, belt, body armor).

Optionally, the gameset comprises at least two headgear, each headgear configured to be worn by a player, coupled to a receiver and comprising a liquid reservoir, and at least two toy weapons, each toy weapon comprising at least one of a motion sensor or an impact sensor, and a transmitter. Optionally, each transmitter is in electronic communication with one of the receivers. Optionally, the toy weapon is a sword, club, hatchet or cudgel or shield. Optionally, the toy weapon comprises at least a motion sensor, and said motion sensor is an accelerometer. Optionally, the headgear further comprises a valve controlled by a solenoid or by a motor. For example, the motor may be a bi-metallic switch. Optionally, the gameset further comprises an electronic display screen. Optionally, the electronic display screen is a television monitor or computer monitor. Optionally, the electronic display screen is located on a mobile phone, said mobile phone also comprising a microphone, a processor, and a speaker. Optionally, the one or more power sources comprises a first power source configured to power the transmitter and a second power source configured to power the receiver. Optionally, the toy weapon comprises one or more buttons or switches configured to be activated by one or more players. Optionally, upon reception of the signal from the transmitter, the receiver is configured to cause liquid from the liquid reservoir to be dispensed downward onto the player, said dispensing aided and not hindered by gravity. Optionally, the headgear further comprises a fill hole and a cap for sealing the fill hole. Optionally, the headgear further comprises one or more exit ports configured to dispense liquid from the liquid reservoir onto the player. Optionally, the headgear comprises a plurality of exit ports, wherein dispensing of liquid through the exit ports is regulated by at least one diverter valve, and further wherein the gameset comprises a controller (e.g., a knob or electronic controller) to selectively operate the diverter valve(s) so that the player(s) can determine which exit port(s) dispenses the liquid. Optionally, at least one of the exit ports is configured to dispense water on the back of the neck of the player to, for example, prevent damage to an electronic component if the component is not waterproof. Optionally, the gameset further comprises a game controller comprising a waterproof housing, which may, for example, comprise silicone and/or one or more gaskets. Optionally, the toy weapon further comprises a light configured to illuminate the toy weapon. Optionally, the toy weapon further comprises a speaker configured to emit sound from the toy weapon, and the speaker may, for example, emit sounds in response to movements or other game activity.

The gameset may be used in any suitable method. For example, the gameset may be used in a method of play involving one or more players comprising one or more of the following steps: a) providing the gameset; b) activating “ON” switches to provide power to all electrical or electronic componentry; c) placing the headgear on one or more player's heads; d) players moving one or more of the toy weapon(s); e) sensing movement and/or impact of one or more toy weapon(s) using the motion sensor(s) and/or the impact sensor(s); f) transmitting a signal from the transmitter to the receiver; and g) dispensing liquid from the liquid reservoir onto a player wearing the headgear in response to the receiver coupled to such player receiving the signal. For example, a player may cause water to be dispensed on himself or herself by moving his or her toy weapon or alternately a first player may cause water to be dispensed on a second player by moving his or her (i.e., the first player's) toy weapon. Optionally, the gameset further comprises an electronic display screen and the method further comprises displaying imagery on the electronic display screen. Optionally, the method comprises dispensing liquid from the liquid reservoir onto the back of the neck of the player wearing the headgear. Optionally, the headgear further comprises a valve controlled by a solenoid or by a motor and the method comprises opening the valve and dispensing liquid downward from the liquid reservoir onto the player wearing the headgear in response to the receiver receiving the signal, said dispensing aided and not hindered by gravity. Optionally, the method comprises dispensing liquid downward from the liquid reservoir onto the player wearing the headgear, without a pump to assist water dispensing, in response to the receiver receiving the signal, said dispensing aided and not hindered by gravity. In addition, the gameset may include one or more features described above.

In still further embodiments, the gameset may be used in a method of play involving two or more players that may include one or more of the following steps: providing the gameset, wherein the gameset comprises at least two headgear, each headgear configured to be worn by a player, coupled to a receiver and comprising a liquid reservoir, and at least two toy weapons, each toy weapon comprising a transmitter and at least one of either a motion sensor and an impact sensor; placing the headgear on each player's head; holding a respective toy weapon in a first player's hand; sensing movement and/or impact of the respective toy weapon using the respective toy weapon's motion sensor and/or impact sensor; transmitting a signal from the transmitter of the respective toy weapon to the receiver coupled to a second player; and dispensing liquid from the liquid reservoir onto the second player in response to the receiver coupled to such player receiving the signal. Optionally, the method further comprises at least two toy weapons of each player contacting each other and the method comprises sensing said contact using the respective toy weapon's impact sensor. In addition, the gameset may include one or more features described above.

In still further embodiments, the gameset may include headgear configured to be worn on a head(s) of one player or players and each such headgear may comprise a liquid reservoir configured to hold a liquid; receiver(s) coupled to the headgear; a waterproof game controller(s) comprising a transmitter(s) to transmit a signal to said receiver; and one or more power sources configured to power the transmitter(s) and the receiver(s). Optionally, upon reception of the signal from a transmitter, the receiver is configured to activate dispensing of liquid from the liquid reservoir onto a player. In addition, the gameset may include one or more features described above.

In still further embodiments, the gameset may include one or more of the following: headgear configured to be worn on a head of a player and comprising a liquid reservoir configured to hold a liquid; a receiver(s) coupled to the headgear; a toy weapon(s); a target comprising at least one of a motion sensor or an impact sensor, and a transmitter(s) to transmit a signal to the receiver upon reception of a signal from the motion sensor and/or the impact sensor; and one or more power sources configured to power the transmitter, the motion sensor or the impact sensor and the receiver. Optionally, upon reception of the signal from the transmitter, the receiver is configured to activate dispensing of liquid from the liquid reservoir onto the player. Optionally, the toy weapon is a projectile such as a dart. Optionally, the target is a dartboard. In addition, the gameset may include one or more features described above.

### BRIEF DESCRIPTION OF THE DRAWINGS

FIG. 1 illustrates a side perspective view of two players playing a gameset of one embodiment of the present invention, as a combative game competition with handheld blaster guns.

FIG. 2 illustrates side views of the playhat and blaster gun of the gameset of FIG. 1.

FIG. 2A, illustrates a bottom perspective view of the playhat of FIG. 2.

FIG. 3 illustrates a top perspective view of three players playing an electronic tabletop gaming console of one embodiment of the present invention, with one player wearing a playhat.

FIG. 4 illustrates side perspective views of the playhat and electronic tabletop gaming console of FIG. 3.

FIG. 4A illustrates a side perspective view of the playhat of FIG. 4.

FIG. 5 illustrates a top perspective view of three players playing an electronic tabletop gaming console of another embodiment of the present invention; the embodiment of FIG. 5 does not include a playhat.

FIG. 6 is an exemplary schematic of the electronics of the playhat depicted in FIG. 1 and FIG. 2.

FIG. 7 is an exemplary schematic of an electronic circuit of the blaster gun depicted in FIG. 1 and FIG. 2.

FIG. 8 is an exemplary schematic of an electronic circuit of the electronic tabletop game console depicted in FIG. 3 and FIG. 4.

FIG. 9 is a side exploded view of the playhat depicted in FIG. 1 and FIG. 2.

FIG. 9A is a side exploded view of components of the playhat depicted in FIG. 1 and FIG. 2.

FIG. 10 is a side exploded view of the blaster gun depicted in FIG. 1 and FIG. 2

FIG. 11 is a side exploded view of the electronic tabletop gaming console depicted in FIG. 4.

FIG. 12 is a perspective view of exemplary headgear that includes an adjustable bracket to provide removable attachment of a smartphone.

FIG. 13 is sideview of headgear that illustrates the placement and location of a reflective surface in the line of sight of the wearer of the headgear.

FIG. 14 is a perspective view depicting two players of the system of the invention in the same location, both wearing headgear of the game system and one player experiencing water penalty.

FIG. 15 illustrates a handheld controller in the shape of a toy blaster gun.

FIG. 16 is an exemplary depiction of more skeletally structured headgear, with fill port and exit port for liquid.

FIG. 17 is an illustration of two players in remote locations, one at a computer and keyboard and one holding a handheld controller of the invention.

FIG. 18 is an illustration of exemplary eyewear in the form of goggles and illustrating digital images of both the virtual reality experience and also a camera view of an opponent.

FIG. 19 depicts a minimalistic design for headgear that contains all elements within the design of an enlarged set of special eyeglasses.

FIG. 20 is an example of a small game console format for a controller of the game system, with a permanent or removably attached electronic display.

FIG. 21 depicts a wearer of headgear playing a game with the system of the invention employing a handheld console with electronic display.

FIG. 22 is a small desk console of the invention.

FIG. 23 illustrates an embodiment of the invention in which a player holds a handheld controller-console, and the electronic display is attached to the headgear of the game system.

FIG. 24 illustrates two players (Player A and Player B) of one embodiment of the gameset of the present invention engaging in role-play make-believe combat, each player holding and manipulating a toylike weapon sword that contains electronic components of the gameset that can transmit a wireless signal to the headgear of the other player.

FIG. 25 illustrates certain movements of the toylike weapon by a player.

FIG. 26 illustrates a schematic view of a toylike weapon of the gameset of one embodiment of the present invention.

FIG. 27 illustrates an exemplary schematic of the electronic circuitry for the headset shown earlier in FIG. 24.

FIG. 28 illustrates a front, perspective view of exemplary headgear, or helmet, of the gameset of one embodiment of the present invention.

FIG. 29 illustrates a front, perspective view of exemplary headgear, or helmet of the gameset of one embodiment of the present invention.

FIG. 30 illustrates two players being enabled and empowered by the components of the gameset of one embodiment of the present invention to compete in a gaming activity while being situated physically remote one from the next.

FIG. 31 illustrates a side, perspective exploded view of exemplary headgear of the gameset of one embodiment of the present invention.

FIG. 32 illustrates a bottom perspective view of exemplary headgear of the gameset of one embodiment of the present invention.

FIG. 32A illustrates a side perspective view of the diverter valve of the exemplary headgear of FIG. 32.

FIG. 33 illustrates a side perspective view of an exemplary projectile and a target of a gameset of another embodiment of the present invention.

### DETAILED DESCRIPTION OF THE DRAWINGS

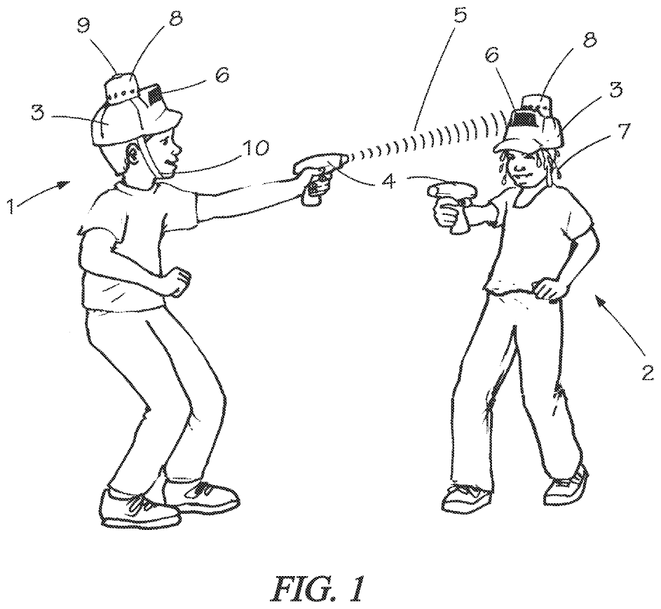

### The Embodiments of FIGS. 1-11

As described in the parent applications, with reference to FIGS. 1-11, the present disclosure generally provides a game for delivering water or other liquid onto a player's head. In some embodiments, the present disclosure provides a system that includes at least two components: 1) a transmitter unit, which may be in the form of a toy blaster gun or electronic tabletop game console for example, comprising a transmitter that transmits a wireless signal to a receiver unit; and 2) the receiver unit, which may be in the form of headgear, such as a playhat, worn by a second player for example, and includes a receiver for receiving the wireless signal. Then in response, water or another liquid is dispensed from a liquid container located on the headgear onto the second player's head. The toy blaster gun may include a handle and trigger for example. In other embodiments, the electronic tabletop game console itself directly sprays water or other liquid onto the player. These and additional embodiments are described below, together with additional optional features.

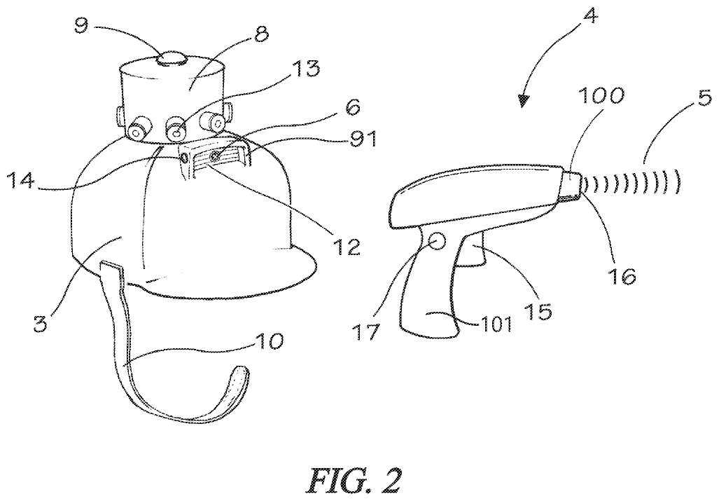

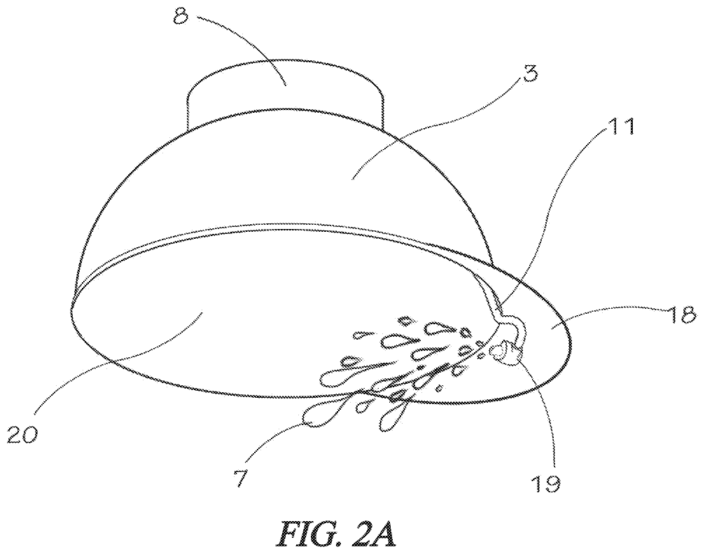

Referring now to FIG. 1, players 1 and 2 are depicted each holding a toy blaster gun 4 that includes a transmitter 100 for transmitting a wireless signal(s) such as an infrared signal, when a trigger 15 is depressed. Radiating lines 5 represent the infrared signal as it is traveling to electronic signal receiver 6 coupled to the headgear, namely, a playhat 3 that each player 1 and 2 is wearing. Preferably, playhats 3 are in the form of a helmet as illustrated in FIG. 1. Said playhats 3 each contain a liquid container 8 that can release liquid preferably water 7 onto the head of a player wearing the playhat 3. Though not shown in a drawing, it is understood by someone skilled in the art of gaming and toy invention that a haptic “penalty” such as the activation of mild electric shock by a low-voltage power source of the invention, or a small motor such as a Mabuchi toy motor with an off-center weight affixed to its shaft to generate a vibration and powered by the power source of the invention can provide an exciting haptic penalty in place of or in conjunction with the release of water onto a player's head. Current and prior-marketed toys such as ballpoint pens that shock a holder as a gag, or Hasbro's “Perfection” game that vibrates wildly to startle a player, are examples of haptic penalties. Playhats 3 can each have a liquid (preferably water) fill location hole that can be sealed by a removable or pivotable cap 9. The players 1 and 2 would stand at a distance from one another and partake in an action sport competition commonly referred to as “laser tag” where each player is attempting to score points by transmitting a signal to a remote receiver on an opponent's body-worn equipment, preferably their head. In the unique invention of this application, instead of simply sounds and scoring being activated, water is released onto the head of a player who is wearing a water-containing playhat 3 that responds to a wireless signal 5 transmitted by a transmitter 100 of a toy blaster gun 4 of another player. A playhat 3 could be held securely in place on a player's 1 and 2 head by a retainer strap 10. Other wireless signal technology could be employed instead of infrared, such as radio frequency signals or Near Field technology or light beams. Infrared is a preferred embodiment for this invention since the infrared beam is very easily directed in a particular direction (for example, by a molded shield or mask that would require the beam-transmission to be accurately directed by the player holding the blaster gun 4), thus reinforcing the play pattern of one player (for example, player 1) aiming their blaster gun 4 at player 2, while player 2 is attempting to avoid his or her receiver 6 from receiving the wireless signal 5. Directional control of the wireless signal is further detailed in the description of FIG. 2, below. Toy blaster gun further includes handle 101.

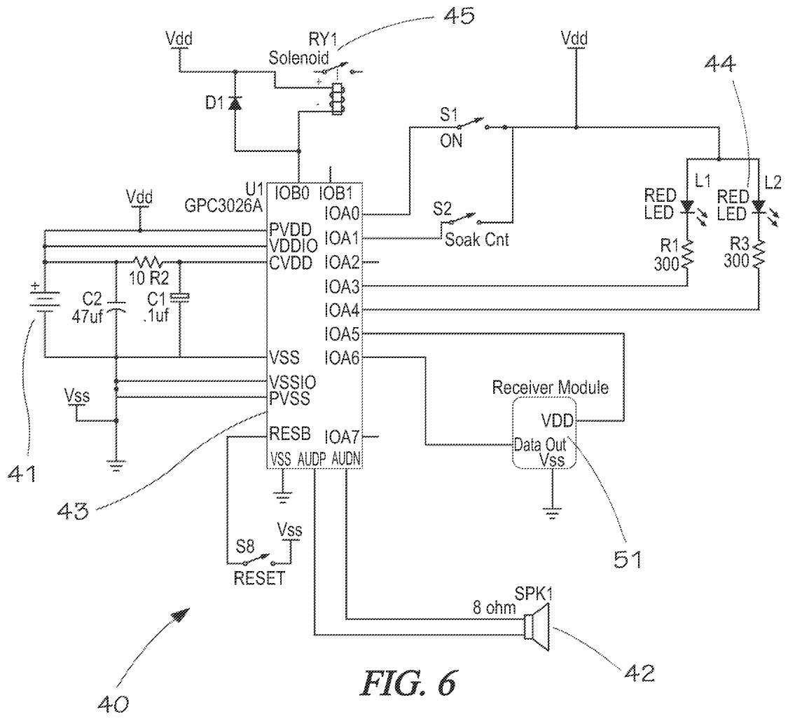

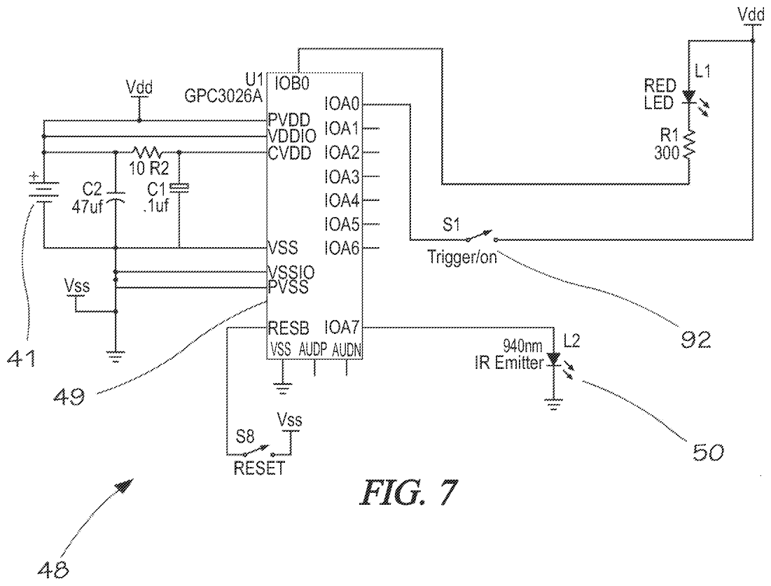

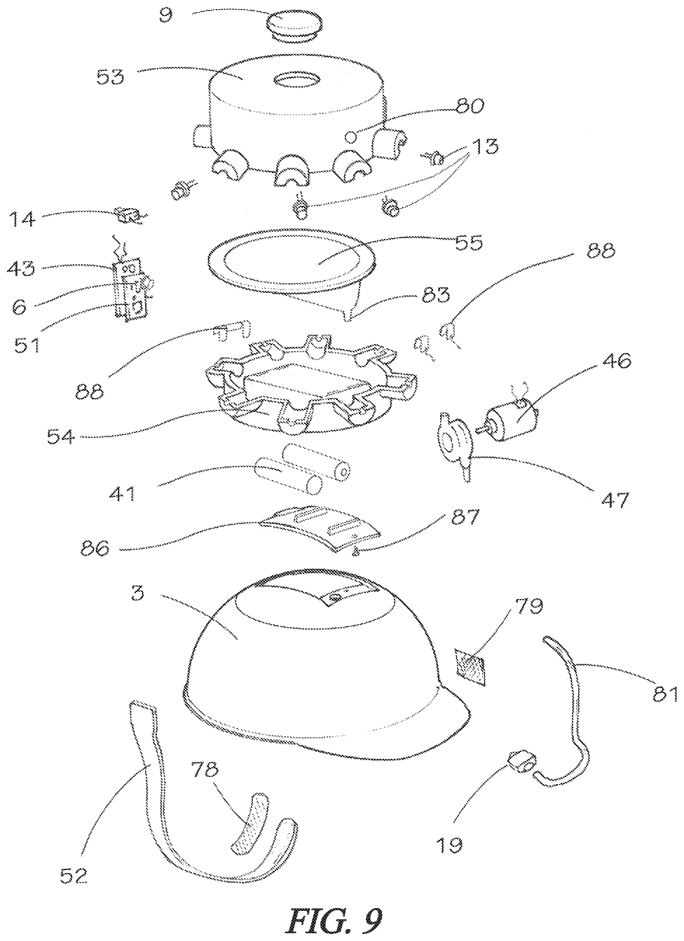

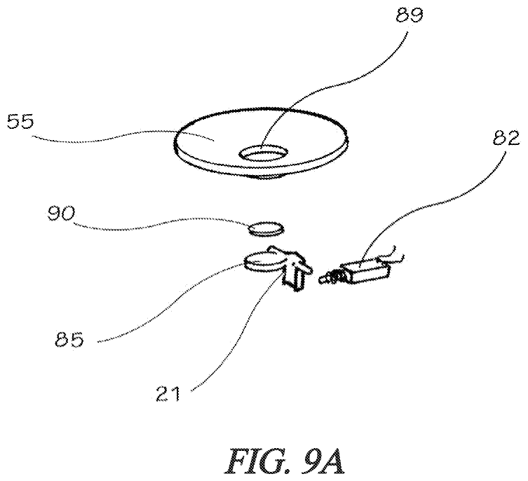

FIG. 2 illustrates the parts of the embodiment shown in FIG. 1. Playhat 3 can be manufactured of high impact styrene or similar moldable plastic material such as ABS or polyethylene or polypropylene. Retainer strap 10 could be vinyl or similar flexible material. Alternatively, an internal adjustable headband, not shown, could be positioned in the playhat 3 interior. Coupled to the playhat 3 is an electronic signal receiver 6 positioned in a visually unique “target area” 12 of said playhat 3, so that another player can see where to aim their toy blaster gun 4 during a play round. Sidewalls 91 at the target area of playhat 3 provide a certain measure of “aim-requirement” for wireless beam direction to provide for gaming challenge, requiring opponents to aim their blaster gun 4 accurately. Furthermore, the shape of the LED transmitter lens of the blaster gun 4 can be so shaped as to affect the beam shape as it exits the blaster gun 4. Infrared technology, the preferred wireless signal embodiment for the handheld blaster gun gameplay, can be specified as being infrared laser, or narrow-beam or wide-beam infrared (all commonly known to those skilled in the art) to further enhance gameplay aiming to activate water release. Playhat 3 includes a switch 14 (e.g., an on/off switch) to activate the internal electronics shown in FIG. 6. Players 1 and 2 fill the liquid container 8 on each playhat 3 with water by pouring water into a hole underneath the removable cap 9. Players 1 and 2 activate the electronics in their playhat 3 by pressing the ON switch 14. Sounds could be emitted to signal that the playhat 3 circuitry was ready for play. LED lights 13 could illuminate and then stay lit or else blink during play rounds, or when a playhat 3 received a wireless signal 5 from an opponent's blaster gun 4. Each blaster gun 4 could be molded from injection molded high impact styrene plastic, or equivalent material commonly used to manufacture toys, such as ABS. Blaster guns 4 are depicted with a movable trigger 15 that when depressed activated the blaster gun transmitter 100 to transmit a wireless signal beam 5 from the front tip 16 of said blaster gun 4. Blaster gun electronic circuitry 40, illustrated in greater detail in FIG. 7, is activated by a player pressing a blaster gun ON switch 17. FIG. 2A shows a bottom perspective view of the playhat 3. Water container 8 is situated on top of the playhat 3. A water tube 11 has a proximal end connected to the water container 8 and a distal end connected to at least one spray nozzle 19 which in this embodiment is coupled to the underside of the hat brim 18 and therefore pointed towards the forehead of the players 1 and 2 wearing the playhats 3. It is understood there can be more than just one spray nozzle 19, and that said spray nozzle(s) 19 could be positioned any place inside the hat cavity 20, which also includes the player's head when the playhat 3 is worn. Alternatively, instead of a spray nozzle 19 (more clearly illustrated in FIG. 9), the delivery of released water 7 could be accomplished by the opening of a mechanical valve assembly 21 (FIG. 9A) to simply allow the water 7 to flow down from the water container 8 onto the head of the player 1 wearing the playhat 3, eliminating the requirement for any motorized pumping action. In an embodiment, water is not pumped from the liquid container 8 by a motorized pump but instead falls by gravity for example, though the mechanical valve assembly 21 may be powered. Preferably, however, a pump 47 is utilized to pump water from the liquid container 8.

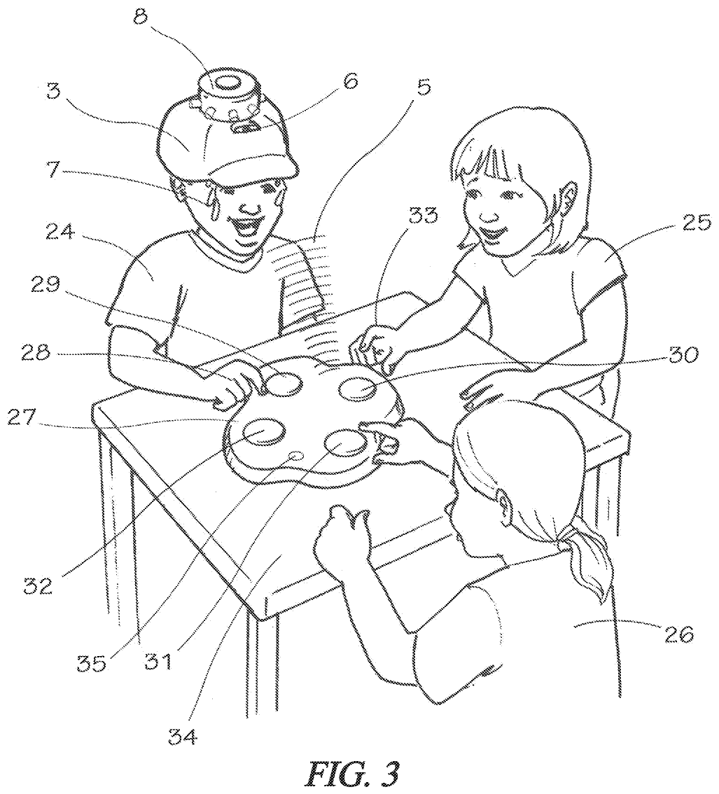

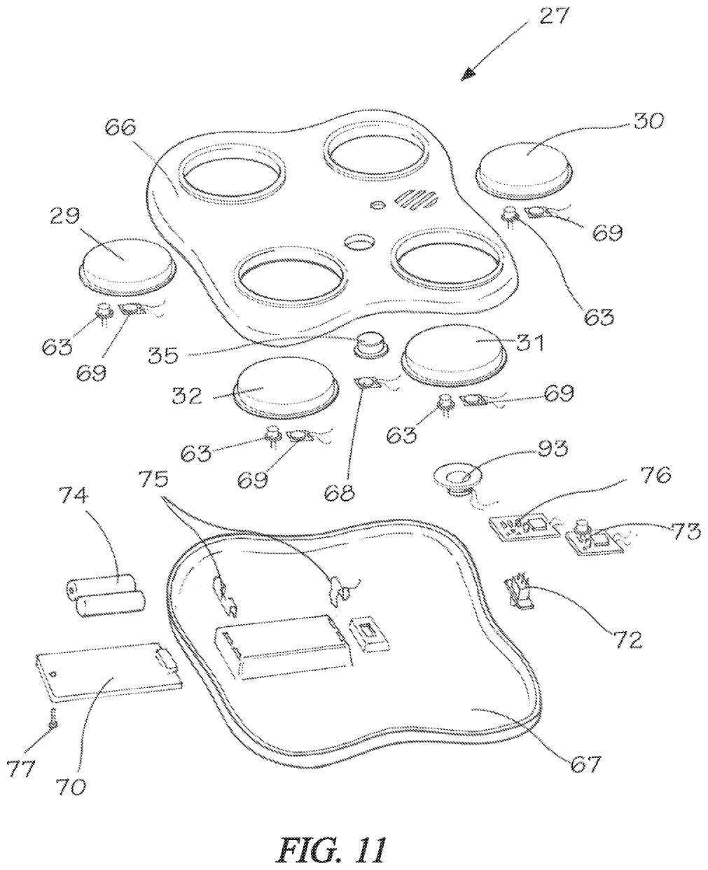

FIG. 3 illustrates an alternative gaming activity for the invention, in which the playhat 3 is worn by only one player 24, 25 or 26 of the game. All players, as illustrated by three players 24, 25, and 26, are seated at a game table 34. Players' hands 28 and 33 are depicted as being positioned above their respective play buttons 29, 30, 31, and 32. Electronic tabletop game console 27 is positioned on game table 34. (Electronic tabletop game console 27 is described in greater detail in FIG. 11). Play buttons 29, 30, 31, and 32 are situated atop the electronic tabletop game console 27. Players 24, 25, and 26 play a game as programmed into said electronic tabletop game console 27, and can, for example, be required to press a play button or buttons 29, 30, 31, and 32 in response to game rules and programming in the electronic circuitry of said console 27. When a specific play pattern is achieved (for example the wearer 24 of the playhat 3 failing to complete a light sequence by failing to press his play button 29 at the proper time) a wireless signal 5 can be emitted from the game console 27 to be received by the electronic signal receiver 6 in the playhat 3, activating the release of water 7 onto the head of the seated player 24. Exemplary gameplay could be as follows, it being understood that some of the order of events might vary:

A. The electronic tabletop game console 27 is activated by system button 35;

B. The water container 8 of playhat 3 is filled with water;

C. The playhat 3 is turned on via a switch 14, at which time LED's 13 can illuminate;

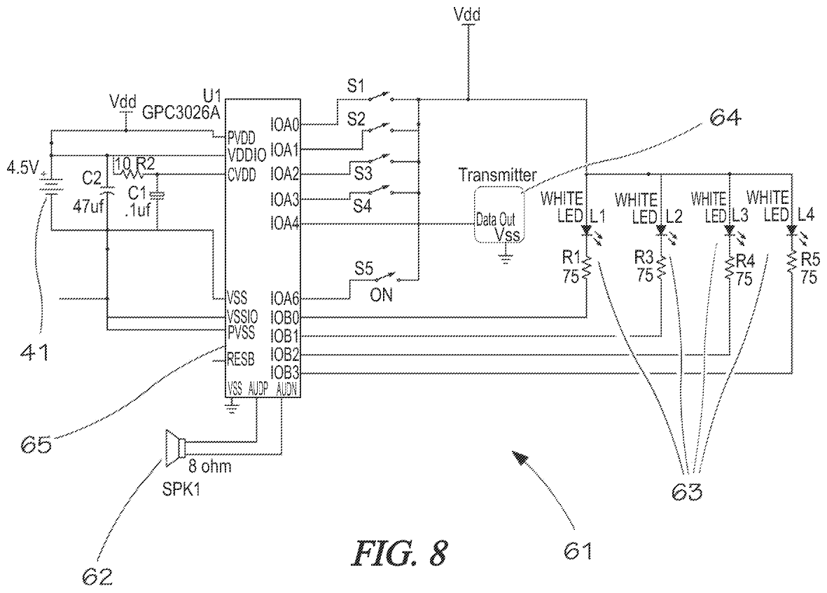

D. Players 24, 25, and 26 are seated at a table 34 and can press their respective buttons 24, 25, and 26, one at a time, to inform the circuitry 61 (see FIG. 8) how many players are playing, and also inform the circuitry 61 which player 24, 25, or 26 is wearing the playhat 3 (since the penalty of water release is contingent upon who is wearing the playhat 3 when a round is terminated). Informing the electronic tabletop game console circuitry 61 as to which player 24, 25, or 26 is wearing the playhat 3, can for example be accomplished in this manner: players can be instructed that the one player wearing the playhat 3 must press their electronic tabletop console game button 29 first;

E. Players 24, 25, and 26 select a particular gameplay (perhaps by pressing system button 35 several times) and then proceed to play the selected game by one or each player pressing play buttons 29, 30, and 31, respectively, on the electronic tabletop game console 27 in response to specific game rules (such as repeat a light sequence, or repeat a light sequence and add one);

F. A play event is completed (for example all players successfully complete a play button pressing sequence; OR the player 24 wearing the playhat 3 failing to press his play button 29 in time);

G. A wireless signal 5 is transmitted to a compatible wireless receiver 6 located on the playhat 3;

H. Water 7 is released onto the head of the player 24 wearing the playhat 3;

I. The play round concludes and the playhat 3 is passed to another player 25 or 26 at the table 34, for example to the player 25 to the left of the player 24 that just got wet.

Alternatively, a similar gameplay scenario can be played by all players and in the event one player who is not wearing the playhat 3 interrupts a button pressing sequence by failing to press their play button 29, 30 or 31 in time; then their respective console light (for example a light on button 31 for player 26) would blink, the round would end, and the player who had been wearing the playhat 3 for the just-concluded play round would remove the playhat 3 from their head and pass it to player 26, who would then put on the playhat 3 and wear it for the next play round. It can be understood that the electronic tabletop game console 27 as disclosed herein this application could be replaced by a mobile phone (i.e., a smartphone or tablet) that provides a game app and then emits a wireless signal 5 compatible and communicable with the receiver 6 in the head-worn playhat 3. The word “mobile phone” as used herein includes smart phones and tablets. For example, a playhat 3 as earlier described could be wirelessly connected to a Wi-Fi signal and then a game app, played on one or more smartphones, could coordinate to send Wi-Fi signals to a playhat 3 or playhats 3 to activate the release or spray of water 7 on a player or players 24, 25 or 26. Two or more players could compete on the same tablet or smartphone, or on separate tablets or smartphones. The first player to complete a gaming challenge sequence could transmit a wireless signal 5 that would then activate the release of water 7 onto the head of their opponent. In a more costly embodiment, a playhat 3 of the invention could be equipped to directly receive a wireless signal 5 from a smartphone or tablet, either from a smartphone or tablet already equipped to transmit infrared or radio frequency or Bluetooth signals, or via a connectable dongle device attached to said smartphone or tablet that then transmitted the necessary signal compatible to the signal convention of the playhat receiver 6. Such technology is typically understood by those skilled in the art of toy gaming electronics.

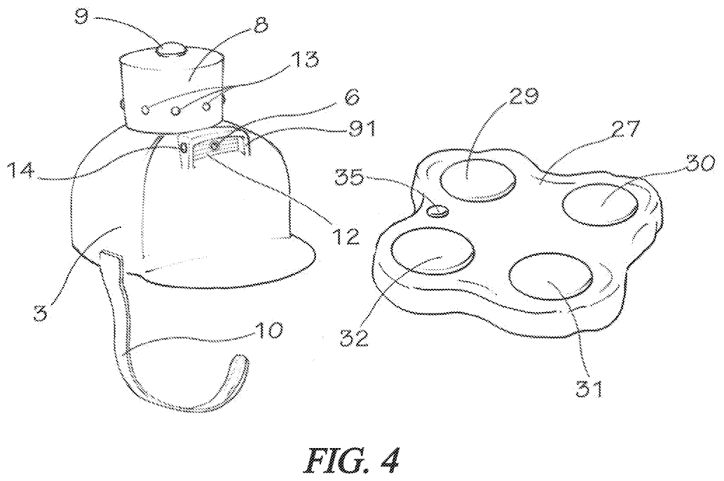

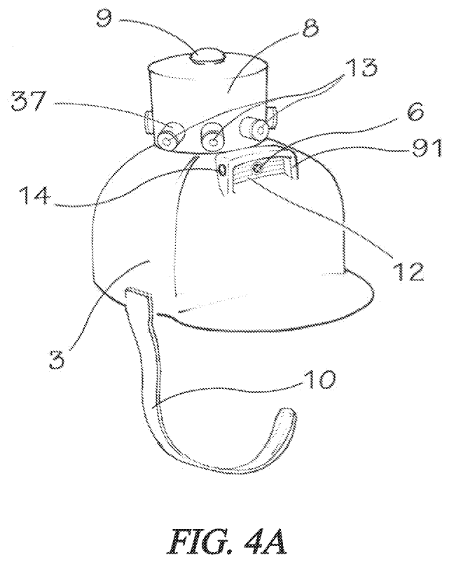

FIG. 4 shows the playhat 3 and electronic tabletop game console 27 in greater detail. Elements of the playhat 3 and electronic tabletop game console 27 are as earlier described. A system button 35 on electronic tabletop game console 27 can be depressed to turn the electronic tabletop game console 27 to an “ON” state or to reset the electronics within the electronic tabletop game console 27 for a new game session, or to select one of several pre-programmed gameplays. Button 14 activates the circuitry 40 inside the playhat 3. Electronic signal receiver 6 is visible in an area of the playhat 3 that can be molded for targeting by a gaming opponent. LED's 13 can be located on the playhat 3, preferably at the lower region of the water container 8. Said LED's 13 can illuminate and blink or flash to signal an ON state and also to signal when a water release event occurs. FIG. 4A illustrates the LED's 13 being located at the tips of molded plastic rods 37, to simulate the iconic design of the classic toy “WETHEAD”, the invention described herein is intended to be a technical advancement and improvement over said classic and successful toy. Rods 37 need not be removable for any reason and could in fact be molded integral to said water container 8. It is obvious that the shape of water container 8 can vary and need not be a cylinder.

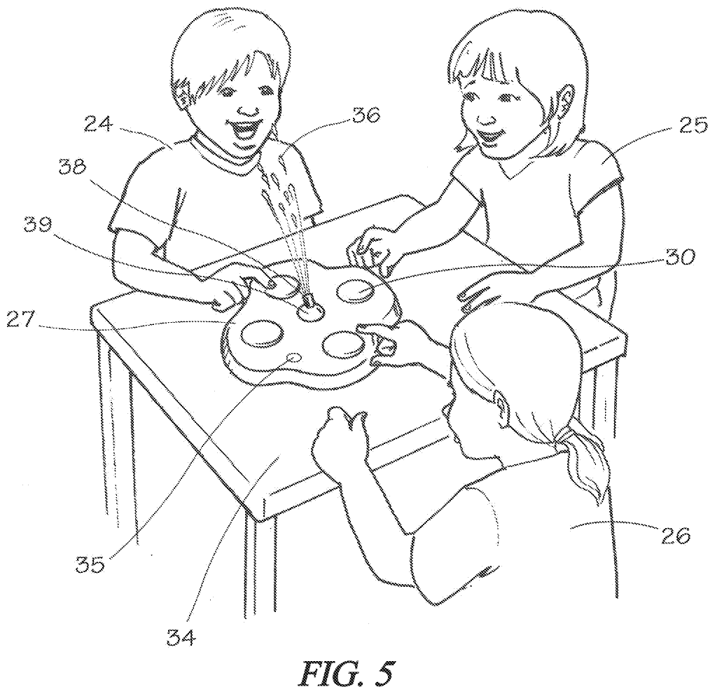

FIG. 5 illustrates a slight modification to the play pattern of the invention, in that the spray event at the conclusion of a gameplay round does not involve water 7 being released from a playhat 3, but instead has water spray 36 being sprayed at a player (in this illustration, player 24) directly from the electronic tabletop game console 27. The water container (not shown) would be inside the electronic tabletop game console 27. Prior to the beginning of a game round, a movable nozzle 38 could be pointed towards one particular player (in this example, player 24) by means of a pivotable turret 39. Alternatively, the water 7 could be directed to spray onto all players, so that gameplay would be modified to require cooperation between players so no one lost a round, to avoid all players getting sprayed. The play activity would best be played on a table 34 as earlier mentioned.

FIG. 6 illustrates an exemplary schematic of the electronic circuitry 40 for the playhat 3, understandable by anyone familiar with the art of simple toy electronics. A battery or batteries 41 provides power for the circuitry 40. Said battery or batteries 41 could for example, be alkaline or nickel metal hydride, disposable or rechargeable. Lithium batteries could be utilized. Battery technology is commonly known for simple electronic toys. Voltage could preferably be 1.5 to 9 volts, direct current. These battery characteristics are representative of additional battery power sources mentioned in this patent application. Said circuitry 40 is intended to receive a wireless signal 5 (FIG. 1) when said wireless signal 5 is transmitted from a toy blaster gun 4 (FIG. 1) and received by a receiver labelled 51 in FIG. 6, initiating a series of programmed events in said playhat 3. Preferably the wireless technology utilized by the components of this invention would be infrared signal transmission and reception, as said technology is able to be directionally controlled. A speaker 42 could be provided to generate sounds when the circuitry 40 was turned on, activated during a gameplay sequence, or shut off. A circuit board 43 can be programmed to control and provide for gameplay logic, timing, and water release commands, as well as LED light 44 illumination. A solenoid controller 45 could send a signal to solenoid 82 to release water 7 from the water container 8 (FIG. 1) by moving a valve 85 (FIG. 9A). Alternative to a solenoid, a toy motor 46 (FIG. 9), for example a Mabuchi RE-280RA 6-volt DC motor 46 (FIG. 9) could be employed and activated by said circuitry 40 to activate a valve or pump 47 to release or pump water 7 onto a player's head.

FIG. 7 illustrates an exemplary schematic of the electronic circuitry 48 for the toy blaster gun 4, understandable by anyone familiar with the art of basic toy electronics. The circuitry 48 is intended to emit a wireless signal beam 5 (FIG. 1) when a player holding said toy blaster gun 4 moves trigger 15. Battery source 41 powers said circuitry 48. Circuit board 49 can be programmed to provide for wireless signal transmission when a user moves a trigger 15 (FIG. 1) activating a circuitry trigger switch 92 on said circuitry 48. A beam transmitter 50 can emit a wireless signal 5 that could be directed to the beam receiver 51 (FIG. 6). Although preferably the wireless technology utilized by the components of this embodiment of the invention would be infrared signal transmission and reception, as said technology is able to be directionally controlled, in the event radio frequency signaling is substituted, beam transmitter 50 and beam receiver 51 would, in that embodiment, be compatible with radio frequency technology.

FIG. 8 illustrates an exemplary schematic of the electronic circuitry 61 for the electronic tabletop game console 27, understandable by anyone familiar with the art of basic toy electronics. The electronic circuitry 61 is intended to provide gameplay activity for one to four players, requiring players to activate switches or buttons 29-32 (FIG. 3) in conjunction with game rules. For example, the programming of said electronic tabletop game console 27 could require that each player must touch-activate their respective button 29-32 within a designated time period after it has been illuminated by the circuitry 61. For example, one player of the game could be wearing the playhat 3 (FIG. 3). In this embodiment of the invention radio frequency (“RF”) or Near-Field technology or Bluetooth technology, for signal transmission by console transmitter 64 might be preferred over infrared technology, since the location of the compatible receiver 6 inside the playhat 3 would vary in location as the playhat 3 might be transferred from one seated player to another seated player, in accordance with gameplay rules. For example, a player who failed to touch-activate his console button 29, 30, 31, or 32 but was not wearing playhat 3 when he failed, might then be required to wear the playhat 3 for the next round of play. In the event any player who happens to be wearing playhat 3 fails to touch-activate his button within the required time, then the circuitry 61 could generate and emit a wireless signal, represented by signal beam 5 (FIG. 3). Said signal beam 5 would be received by the receiver 6 and water 7 would release, as earlier described. The circuitry 61 could be comprised of a power source such as batteries 41, speaker 62 to emit unique sounds for each play button (29-32) and also special sounds when a spray-signal transmission event occurred. Console LED lights 63 could illuminate the buttons 29-32 (FIG. 3). In any embodiment of the invention, when one particular wireless signal technology such as infrared or radio frequency or Near Field technology was utilized in a transmitter 100, it would be understood that the receiver 6 (for example, in the helmet 3) would be of compatible technology so that wireless communication 5 was effectuated. Console circuit board 65 controls the gameplay and provides for players to select games to play and to press their buttons 29-32 at the outset of a gameplay session to designate how many players might be playing, etc. An exemplary gameplay might be preparing the playhat 3 for play by filling it with water 7 and turning on its circuitry 40 (as described earlier in FIG. 2 description). In accordance with programmed gameplay and player or players input, console transmitter 64 or gun transmitter 100 eventually sends signal to a remote receiver 6, to activate water 7 release.

FIG. 9 illustrates an exploded view of the playhat 3. Strap 52 can secure said playhat 3 onto a player's head, by securing around their chin via hook and loop fastener material 78 and 79, or a snap or buckle. Alternatively, an adjustable flexibly molded inner sizing ring (not shown) could be installed into the playhat 3 and then adjusted for head size fit. Container 8 (FIG. 1) may be generally comprised of top section 53 to hold water 7 and bottom section 54. Bottom section 54 would not contain water 7 in this embodiment but instead could be isolated from the water area by a reservoir bottom 55. Within bottom section 54 could be the electronic and electro-mechanical components of the playhat 3, such as batteries 41, LED's 13, an ON/OFF switch circuit board 43, signal receiver circuit board 51, etc. Coupled to said ON/OFF switch circuit board 43 may be ON/OFF switch 14 that is accessible by the wearer from the outer surface of the playhat 3, and also wireless beam receiver 6, which is controlled by receiver module 51, which could receive a wireless signal 5 from a remote wireless signal transmitter 100 as earlier described. In the event the wireless signal transmission was infrared and required line-of-sight, access portal 80 could be so molded as to directionally provide desired line of sight signal transmission receipt. When the ON/OFF switch circuit board 43 is activated, (in a preferred embodiment) a small motor 46 could activate to activate a pump 47 that would draw water 7 (not shown) from the top reservoir housing 53 and then spray that water 7 through a tube 81 and a spray tip nozzle 19, onto the wearer of the playhat 3. Proximal end of tube 81 could be coupled to the bottom of reservoir bottom outlet 83. Distal end of tube 81 may be attached to the underside of hat brim 18. Batteries 41, battery door 86, battery door screw 87, and contacts 88 are all commonly understood parts and not described in detail. FIG. 9 illustrates an alternative position, on playhat 3, for wireless signal reception, depicting wireless signal beam portal 80 and signal receiver 6 as being situated on the water container 8, as opposed to being situated on the main playhat front area, as shown in FIG. 2.

An alternative means to deliver water 7 onto a wearer of the playhat 3 could be provided by replacing the motor 46 with a solenoid 82, shown in FIG. 9A, although it should be understood that a motor and a solenoid could generally be interchanged in both FIG. 9 and FIG. 9A embodiments, and in fact are often substituted one for another in many toy applications where a small amount of energy is desired for simple parts activation. FIG. 9A further describes the substitution of a pivoting valve plate 85 that is moved to an open position by solenoid 82 to allow gravity flow of the water 7 through hole 89 at the bottom of reservoir bottom 55. If necessary, a flexible seal 90 could be installed to prevent water from leaking when pivoting valve plate 85 was in its closed position. Pivoting valve assembly 21 can be pivotably attached to molded bosses or detents in said playhat inner structure. In the embodiment wherein it is desired for water to be actively pumped out onto the user's head, a motor 46 might be more desirable than a solenoid 82. Battery compartment lid 86 is intended to allow safe access to the batteries 41 for installation and replacement. In the event rechargeable batteries 41 were to be employed, recharging could be via a recharger port, not shown but commonly understood. It is also commonly understood that batteries 41 require contacts to complete their connection to the components utilizing their power, and therefore not illustrated.

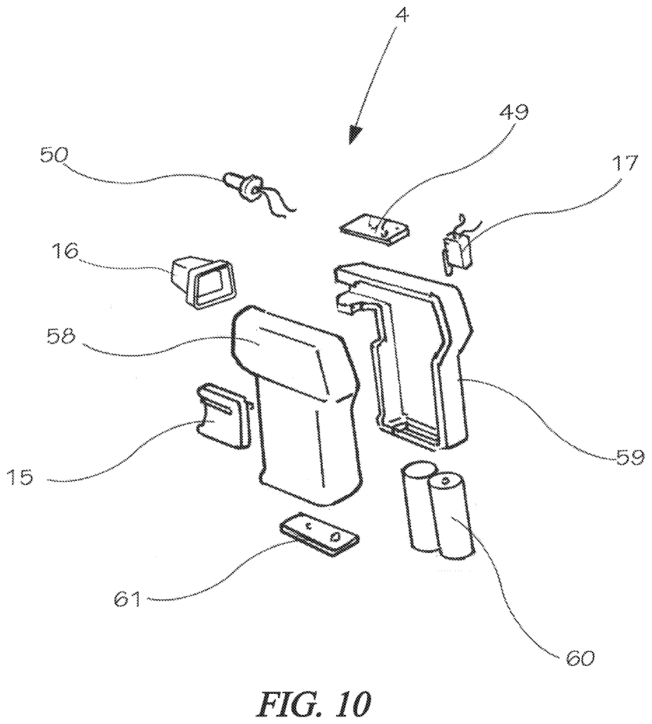

FIG. 10 illustrates an exploded parts view of the toy blaster gun 4 as shown in FIG. 1 and elsewhere. Said blaster gun 4 can include two housing halves, 58 and 59. Said halves 58 and 59 can be coupled together via solvent bond or screws, or one-time snap-together detents, to create the complete blaster gun 4. Inside said blaster gun 4 may be circuit board 49 and batteries 60. Coupled to said circuit board 49 and accessible from the outside of said housing halves 58 and 59 may be a movable trigger 15 that is configured to control signal beam 5 transmission, a master ON switch 17 that would power said circuit board 49 on or off, and an open front tip section 16 to allow wireless beam egress for signal beam 5 (FIG. 1) transmission towards the electronic signal receiver 6 in playhat 3 (FIG. 1). Battery door 61 could be removable to allow safe access to batteries 60, which may be coupled to and provide power to circuit board 49.

FIG. 11 is an exemplary parts breakdown of an electronic tabletop game console 27. Game console housing top 66 and housing bottom 67 could be molded of plastic and could be solvent bonded or screwed together. Electronic tabletop game console 27 could include play buttons 29, 30, 31 and 32 that can be depressed by a player or players to activate their respective switches or micro switches 69. System button 35 could be activated by the players to select a particular gameplay, and to begin the play of a play round, by activating micro switch 68. A master ON/OFF switch 72 could be positioned elsewhere on the electronic tabletop game console 27. Battery door 70 may be retained in position by screw 77 and then removed to access or replace or recharge batteries 74. Wireless signal transmitter board 73 and circuit board 76 may be contained inside electronic tabletop game console 27. Battery contacts 75 are also illustrated. Console speaker 93 can emit unique sounds corresponding to play sequences, correct or incorrect input by players, timing actions, and/or wireless signal transmission (when water-release signal 5 has been transmitted).

The power source for the toy blaster gun 4, electronic tabletop game console 27, and playhat 3 is preferably batteries, however, these components, particularly, electronic tabletop game console 27 could be powered by a wall outlet.

Optionally, the receiver 5 and/or transmitter 100 described herein are transceivers capable of bi-directional communication. For example, in an embodiment of the invention, bi-directional communication takes place between playhats 3 and electronic tabletop game consoles 27 or other physical components. For example, it could be desired that one playhat 3 communicated to another playhat 3 so that the second playhat 3 responded uniquely to a signal from the first playhat 3. To achieve such bi-directional communications receivers 5 and transmitters 100 of the invention, as described herein, could be replaced by transceivers. Thus, the word “receiver” as used herein encompasses both receivers and transceivers. Likewise, “transmitter” as used herein encompasses both transmitters and transceivers.

In some embodiments, the user indirectly or directly manipulates a “switch.” The user may so manipulate the switch by activating the circuitry 40, 48, and 61, or components therein. For example, a user could depress, or fail to depress, a button 29-32, which in turn activates a switch within the electronic tabletop game console circuitry 61, causing the electronic tabletop game console circuitry 61 to generate and emit a wireless signal 5. Alternatively, a switch within playhat 3 could activate the playhat circuitry 40 and cause motor 46 to activate a valve or pump 47 to release or pump water 7 onto a player's head.

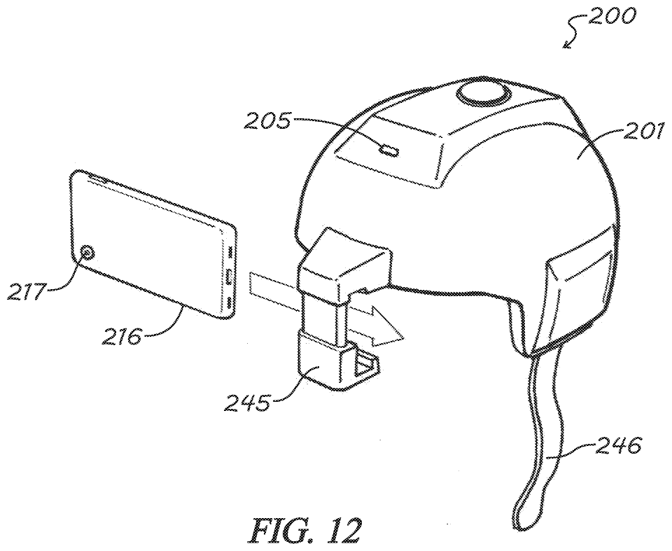

### The Embodiments of FIGS. 12-23

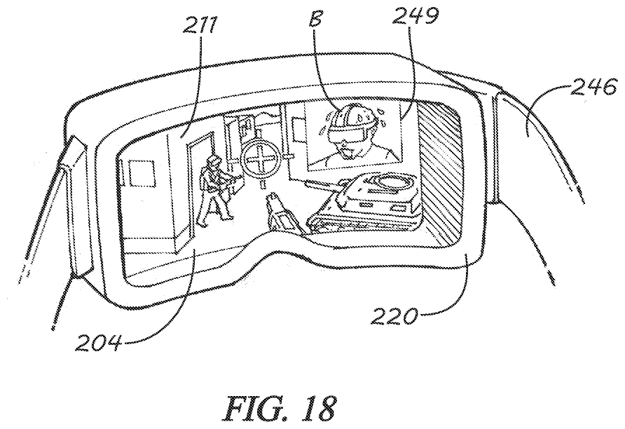

As described in the parent applications, FIGS. 12-23 illustrate an embodiment of a gameset 200 that is particularly adapted to virtual reality represented by image 211 (FIG. 18), mixed reality and augmented reality.

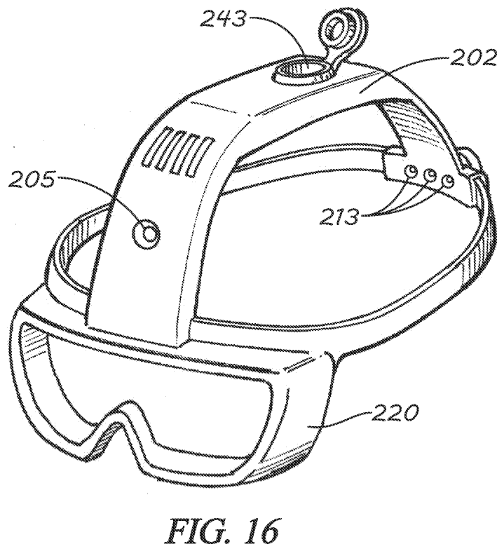

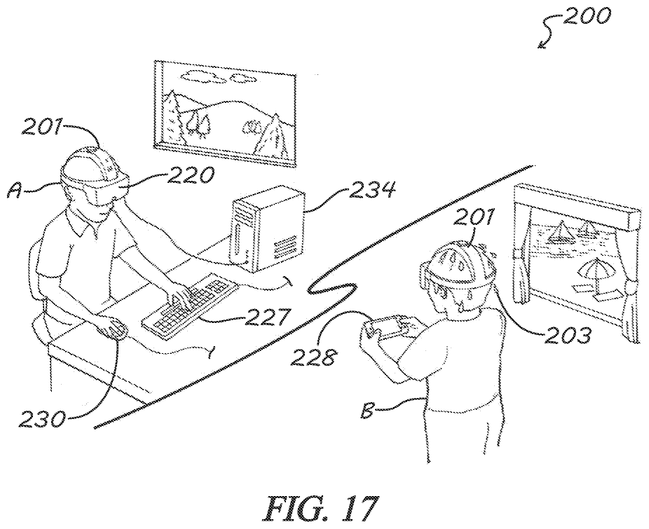

More particularly, in some embodiments, as shown in FIGS. 12-23, the present disclosure provides a gameset 200 configured to emit a liquid 203 onto a player. The gameset 200 may include: headgear 201 configured to be worn on a head of a player and comprising a liquid reservoir 202 (FIG. 16) configured to hold a liquid 203 and an electronic display 204 configured to visually present imagery 211 to the player's eyes (e.g., above, below or in front of the player's eyes—FIG. 17 and FIG. 18); a receiver 205 coupled to the headgear 201; a remote device 206 comprising a transmitter 207 configured to transmit a signal 208 to the receiver 205; and/or one or more power sources configured to power the transmitter 207, the electronic display 204 and the receiver 205. Optionally, upon reception of the signal 208 from the transmitter 207, the receiver 205 is configured to activate dispensing of liquid 203 from the liquid reservoir 202 onto the player's head. As used in the context of FIGS. 12-23, “headgear” is intended to encompass, without limitation, hats, headsets, head-mounted displays, helmets, eyewear such as goggles, and the like. Eyewear and goggles can be transparent, semi-transparent or opaque, depending upon the embodiment of the invention and whether the embodiment provides for augmented or virtual reality, as well as whether the embodiment provides a wearer visual access to an internal electronic display, or visual access to a remote display, such as a computer monitor or external smartphone electronic display. Referring back to receiver 205, FIG. 12 and FIG. 16 illustrate an external receiver that would be preferred to receive a transmitted signal such as an infrared signal. It is understood that other wirelessly transmitted signals that could be utilized in the invention might be radio-frequency, or Bluetooth, etc. which would not require direct line-of-sight communication with a transmitter, in which cases receiver 205 might be an internal component.

Optionally, the signal 208 is a wireless signal. FIG. 17 depicts a seated Player A whose headgear 201 is attached via a wired connection to receive a signal from a computer being employed in this embodiment of the invention. It is at the same time to be understood by anyone skilled in the art that the transmission of data from one remote device (ex: a computer in New York City) to another player's computer or smartphone in another location (ex: Wyoming) could involve both wireless and wired communication between players of gamesets 200 of this invention.

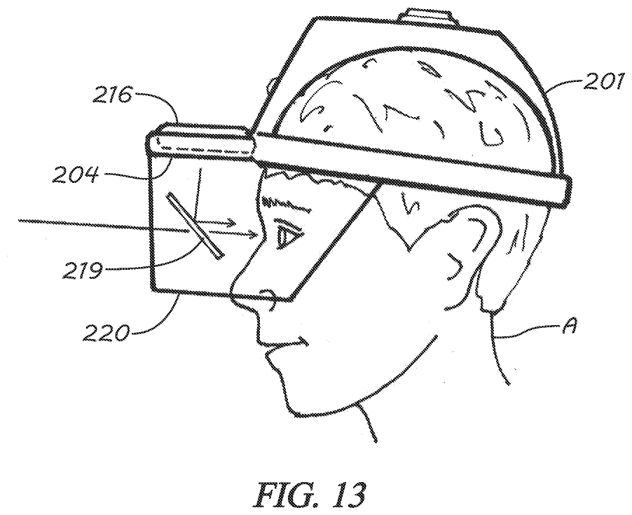

Optionally, the electronic display 204 (FIG. 13 and FIG. 18) is coupled to a processor and visually presents to the player virtual reality imagery, augmented reality imagery, or mixed reality imagery generated by the gameset 200. Optionally, the headgear 201 further comprises a speaker and microphone (microphone not shown—which may be used to capture words or sounds emitted by the player). Optionally, the headgear 201 further comprises a mobile phone 216 comprising the electronic display 204, a speaker, a camera 217 and a microphone. Optionally, for the embodiment of augmented reality play, the mobile phone 216 (FIG. 13) is configured to be located above the player's eyes and the headgear 201 comprises a reflective surface in the form of a transparent or semi-transparent plate 219 configured to be angled and located below the mobile phone 216 in the line of sight to the wearer so that a reflected image from said mobile phone 216 to said plate 219 can be viewed by the wearer as the wearer looks through said transparent or semi-transparent plate 219 with transparent image to simultaneously observe the actual environment in front of his eyes, the result being a combined visual presentation of augmented reality. For the embodiment of virtual reality play, there is no requirement for transparent or semi-transparent plate 219, and the mobile phone 216 is located in front of the player's eyes. There are several directions of development for augmented reality display, including but not limited to OST (optical see through) and VST (video see through). These displays could also be utilized in the headgear 201 of the invention, and are explained online at: https://blog.protypr.io/understanding-display-techniques-in-augmented-reality-c258b911b5c9. For purposes of this invention, the technology illustrated for the display 204 is not critical as it is not being claimed. Display technology options are cited as reference to the workability of the release of liquid 203 upon receipt of a wireless signal 208, and offered as background information.

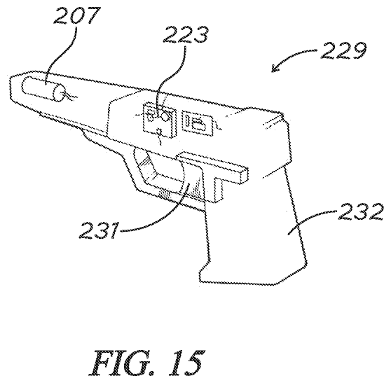

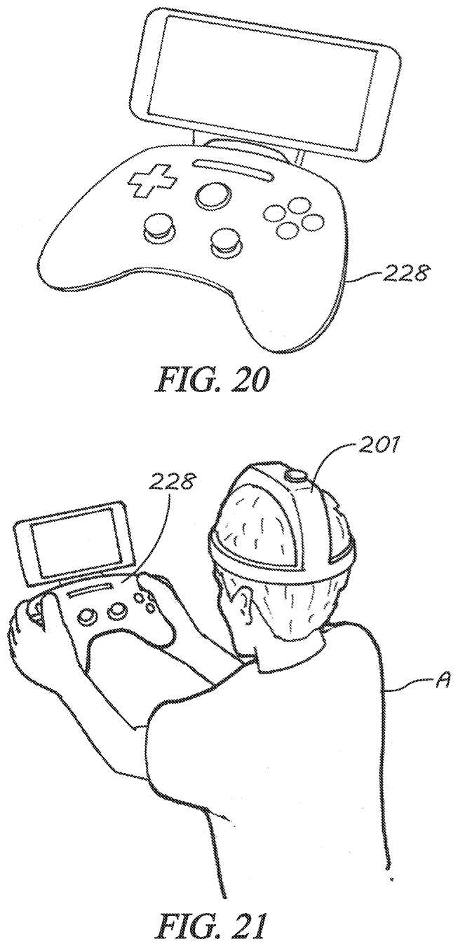

Regardless as to its location in the headgear, optionally the mobile phone 216 is removably attached to the headgear 201 (e.g., by a bracket 245). Optionally, the headgear 201 comprises eyewear 220 comprising the electronic display 204 and a hat comprising the liquid reservoir 202. Optionally, the eyewear 220 is in the form of goggles that may include a strap 246 to extend around the player's head. Optionally, the gameset 200 further comprises a motion sensor, an attitude sensor or an accelerometer 223 that may, for example, detect positioning/movement of the player, headset 201 or blaster gun 229. Optionally, the motion sensor, the attitude sensor or the accelerometer 223 is coupled to the headgear 201. Optionally, the gameset 200 further comprises a controller unit 228. The controller unit 228 in FIG. 20 and FIG. 21 may include a joystick or joysticks, represented by elevated and movable button-like circular units 226. A toy blaster gun 229 or a computer mouse 230 may function as controller units in other embodiments, and may include switches or sensors that will function to generate signals transmitted to a receiver of the invention. Optionally, the controller 228 further comprises a motion sensor, an attitude sensor or an accelerometer 223. One controller unit in FIG. 17 is numbered 227, a keyboard, to differentiate it from a smartphone, 228 in the same FIG. 17, that also can function as a controller. Optionally, the gameset 200 further comprises a toy blaster gun 229 (FIG. 15) comprising a trigger 231 and a handle 232. Optionally, the gameset 200 further comprises a camera (not shown) aimed toward the player to capture video or still image of the player. A smartphone in an embodiment of the invention could provide camera capabilities, or a separate small digital camera might be mounted in a headset of the invention. Optionally, a camera on a computer screen of the invention could record an image of a player. Optionally, the camera 217 is coupled to the headgear 201. Optionally, the gameset 200 further comprises a computer 234 and further wherein the gaming console is coupled to the camera 217. Optionally, the headgear 201 is waterproof. Optionally, the headgear 201 further comprises a valve 237 configured to control release of the liquid 203 from said reservoir 202. Optionally, the valve 237 is controlled by a solenoid or by a motor and further wherein upon reception of the signal from the transmitter 207, the receiver 205 is configured to cause liquid 203 from the liquid reservoir 202 to be dispensed downward onto the player's head, said dispensing aided and not hindered by gravity. Optionally, the gameset 200 further comprises a first computer 234 comprising the transmitter 207 and a first computer processor and wherein the gameset 200 further comprises a second computer 234 comprising the receiver 205 and a second computer processor. Optionally, the headgear 201 further comprises a fill port 243 configured to allow the player to fill the liquid reservoir 202 with a liquid 203 and an exit port 213 (FIG. 16) configured to allow the liquid 203 to exit from the liquid reservoir 202. Optionally, the gameset 200 comprises a computer 234.

In still further embodiments, the present disclosure provides a method of play involving one or more players comprising the steps of: a) providing the gameset 200; b) placing the headgear 201 on the player's head; c) transmitting a signal 208 to the receiver 205; and d) dispensing liquid 203 from the liquid reservoir 202 onto the head of at least one player wearing the headgear 201 in response to the receiver 205 coupled to such player receiving the signal 208. Optionally, the electronic display 204 is coupled to a processor and visually presents to the player wearing said headgear 201 virtual reality imagery, augmented reality imagery, or mixed reality imagery.

In still further embodiments, the present disclosure provides a method of play involving two or more players comprising the steps of: a) providing the gameset 200 with liquid having been filled into reservoirs on the gameset headgear 201 of one or more players; b) placing headgear 201 on the head of a first player and placing the headgear 201 on the head of a second player; c) transmitting a signal 208 from a controller controlled by said first player to a receiver 205 coupled to said second player's headgear 201; and d) dispensing liquid 203 from the liquid reservoir 202 onto the head of said second player in response to the receiver 205 coupled to said second player's headgear 201 receiving said signal 208.

In still further embodiments, the present disclosure provides a method of play comprising the steps of: a) providing the gameset 200 that includes a liquid reservoir 202 filled with liquid 203, wherein the gameset 200 comprises a computer 234; b) placing headgear 201 on the head of a first player and placing the headgear 201 on the head of a second player; c) transmitting a signal 208 from the computer 234 to a receiver 205 coupled to said second player's headgear 201; and d) dispensing liquid 203 from the liquid reservoir 202 onto the head of said second player in response to the receiver 205 coupled to said second player's headgear 201 receiving said signal 208 from said computer 234.

In still further embodiments, the present disclosure provides a gameset 200 that displays an electronic image to a player, said gameset 200 configured to emit a liquid 203 onto a player's head upon reception of a signal 208 by a receiver 205 from a transmitter 207, said receiver 205 configured to activate the dispensing of said liquid 203 from a liquid reservoir 202 coupled to said player's head.

In still further embodiments, the present disclosure provides a gameset 200 that displays an electronic image to a player, said gameset 200 configured to activate a haptic event by example low-volt shock or vibration of a small motor 240 onto a player's head upon reception of a signal 208 by a receiver 205 from a transmitter 207.

In the still further embodiments, the present disclosure provides a gameset 200 configured to emit a liquid 203 onto a player comprising: headgear 201 configured to be worn on a head of a player and comprising a liquid reservoir 202 configured to hold a liquid 203; an electronic display 204 configured to visually present imagery to the player's eyes; a receiver 205 coupled to the headgear 201; a remote device comprising a transmitter 207 configured to transmit a signal to the receiver 205; and one or more power sources configured to power the transmitter 207, the electronic display 204 and the receiver 205. Optionally, upon reception of the signal from the transmitter 207, the receiver 205 is configured to activate dispensing of liquid 203 from the liquid reservoir 202 onto the player's head.

In the still further embodiments, the present disclosure provides a gameset 200 configured to emit a liquid 203 onto a player comprising: headgear 201 configured to be worn on a head of a player and comprising a liquid reservoir 202 configured to hold a liquid 203; a power source; an electronic display 204 configured to visually present imagery to the player's eyes; wherein, upon activation, the liquid reservoir 202 is configured to dispense liquid 203 onto the player's head.

In the still further embodiments, the present disclosure provides a method of dispensing liquid 203 onto a player comprising: a) providing a gameset 200 configured to emit a liquid 203 onto a player comprising: headgear 201 configured to be worn on a head of a player and comprising a liquid reservoir 202 configured to hold a liquid 203; a power source; an electronic display 204 configured to visually present imagery to the player's eyes; b) placing the headgear 201 on the player's head and visually presenting imagery to the player's eyes; and c) dispensing liquid 203 from the liquid reservoir 202 onto the player's head.

FIGS. 12-23 will now be described with more particularity.

FIG. 12 illustrates a molded helmet-shaped headgear 201 embodiment that contains a fill port 243 with a removable cap to provide for the filling of a reservoir 202 with a liquid 203 (preferably water), a retention strap 246 so that the player might not lose the headgear 201 during active play, and a size-adjustable spring-loaded or thread-to-tighten bracket 245 could provide for secure positioning and retention of a smartphone 216 to send and receive wireless signals 208 and data transmission for the gaming activity, and to display digital imagery of the gaming activity to the player wearing the headgear 201. In FIG. 12, the mobile phone (e.g., smartphone) 216 is positioned directly in front of the eyes of the player, so that the gaming experience is virtual reality represented by the displayed image 211 (FIG. 18), with the actual environment (for example backyard or bedroom) of the player playing the game not visible to the player. It is understood that virtual reality gaming headgear 201 may instead of a smartphone display 204, comprise a dedicated digital screen, fixed in place, so that a smartphone 216 would not be required. This is well known to anyone skilled in the art. Headgear 201 could contain speakers for sounds as well as communication between players. Speakers and microphones (not shown) could be integral to a smartphone 216 or else dedicated elements of the headgear 201. In an exemplary embodiment, headgear 201 is in the form of a head-mounted display (HMD).

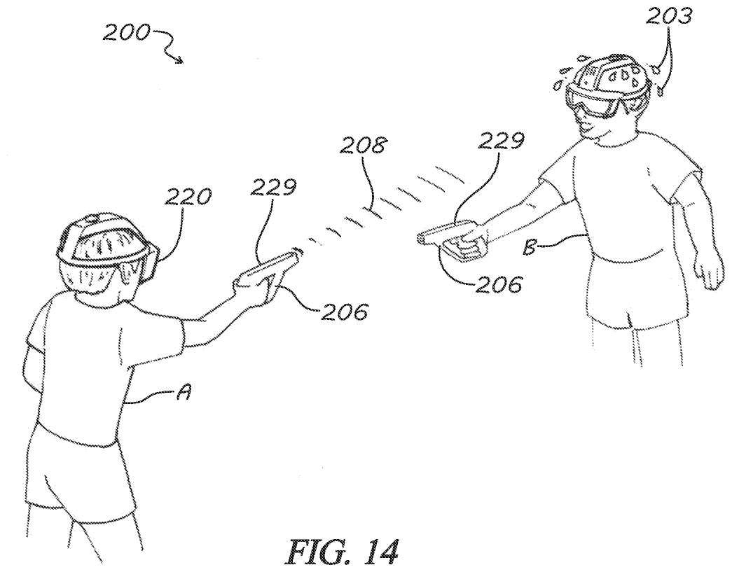

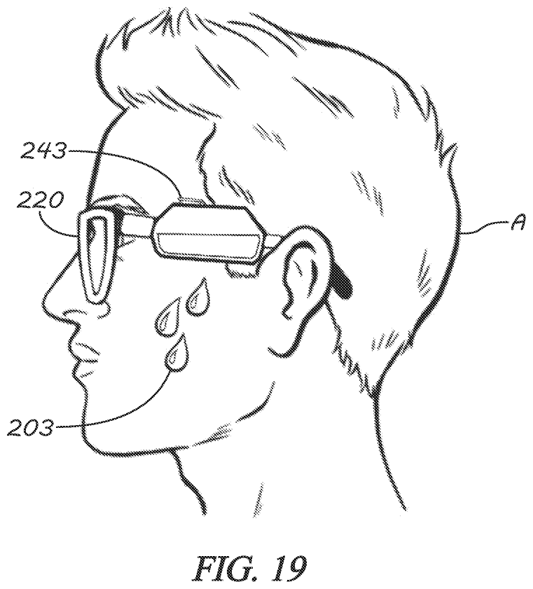

Headgear 201 can be as structurally complete as a helmet (FIG. 12) that covers most or all of a player's head, or can be skeletal in structure (FIGS. 14 and 16), or can be as minimalistic as simulating ear-worn “glasses” 220 with small liquid reservoirs 202 on the temples or front eyeglass portion 220 (FIG. 19), to release liquid 203 preferably water onto the player/wearer. Electronic componentry could be inside the enlarged eyeglass 220 frames.

FIG. 13 depicts headgear 201 wherein an angled semi-transparent plate 219 is positioned in the line of sight of the Player A, so that a digital gaming image projected downward from the electronic display 204 of a smartphone 216 or other projection source is able to be viewed by the wearer simultaneously with the Player A seeing through that projected image to observe the actual surroundings in which the player is playing the game of the invention. Such dual imagery (projected and real-time) is augmented reality, as earlier described herein this application.

Headgear 201 is preferably injection molded plastic such as high impact styrene or polycarbonate or polypropylene, and can comprise a goggle section 220 and an electronic receiver 205 and a power source such as a battery.

Wireless signals 208 transmitted to receivers 205 in varying headgear 201 of the invention can be generated by a variety of alternative components of the system, including handheld blaster guns 229, tabletop game consoles 228, computer keyboards 227, and other well-known dedicated game controllers. All can be activated by an array of one or more triggers 231, joysticks 228, keys or buttons. Such alternative gaming componentry is well known to those knowledgeable in the art of digital gaming and digital gaming equipment. FIG. 14 illustrates two exemplary players (Player A and Player B) of the gameset 200. They may be engaged in a competition involving augmented reality gaming or virtual reality gaming. Each player is holding a blaster gun 229 and pointing their blaster gun 229 at their opponent. Each player has a digital image presented in front of their eyes, or a digital image reflected into their line of sight as previously described as an augmented reality component. Digital image display can be by means of a digital screen as might be included in a smartphone 216 removably coupled to their headgear 201, or by means of a digital screen fixably attached to their headgear 201. In this instance an opponent holding a blaster gun transmitter 207 could emit a wireless signal 208, such as an infrared signal 208, towards a signal sensor on his opponent's headgear 201. The top section of each player's headgear 201 contains a liquid container/reservoir 202 that can be filled through a fill port 243 (FIG. 16) by the players prior to the beginning of play. Each headgear 201 unit can contain a power source and a small circuit board that is programmed to activate the release of liquid 203 from the liquid reservoir 202 upon reception of a wireless signal 208 from another device of the gameset 200. One player of the competition illustrated in FIG. 14 is in the process of having water 203 released onto his head represented by graphical droplets.

Optionally, the remote device is a toy gun 229 (often referred to as a “blaster”) comprising a handle 232 and a trigger 231 connected to the handle 232, and depressing the trigger 231 is configured to transmit the wireless signal 208. FIG. 15 illustrates a small, exemplary handheld “blaster” gun 229 of the invention. The blaster 229 could be any size, to simulate even a large-sized weapon for themed play. It can contain a power source such as a battery, a small integrated circuit board providing the capability to send a wireless signal 208, a trigger 231 to activate signal 208 sending, a speaker (e.g., piezo speaker) for sound generation, lights, an infrared light source that can activate a signal 208 on another remote device 206, etc. The toy gun 229 could also contain a motion senor, attitude sensor or accelerometer 223 so that the position of the blaster 229 and the movement of the blaster 229 could be detected and transmitted to other components of the gameset 200, for purposes of determining accuracy, timing, etc. The wireless signal 208 can be Bluetooth or Wi-Fi signal, although it could also be Nearfield or similar wirelessly transmitted signal 208. In certain gaming embodiments, for example as described above in FIG. 14, the directed-beam of an infrared signal might be preferred for its directionality. In one embodiment, instead of a blaster gun 229, the remote device 206 is a console that further comprises at least one button configured to activate an electronic switch. The remote device 206 can be a mobile phone 216. Optionally, the headgear 201 is further configured to emit lights, sounds or combinations thereof in response to the receiver 205 receiving the wireless signal 208. Optionally, the receiver 205 and transmitter 207 are transceivers capable of bi-directional communication. Optionally, the reception of a wireless signal 208 transmitted from a remote device is accomplished by the inclusion of a smartphone 216 coupled to or positioned inside the headgear 201 or wirelessly in communication with the headgear circuitry, for example by 802.11 b/g/n wireless internet access.

FIG. 16 illustrates a more skeletal structure of headgear 201. The liquid fill port 243 is preferably located atop the headgear 201 and can include a hinged fill cap. An exit port 213 can be positioned at the rear of the headgear as shown. Exit port 213 could be multiple exit ports distributed around the inside of the headgear 201 so that liquid from the liquid reservoir 202 might fully soak a player when liquid release was activated.

A player would open the cap of the fill port 243 (FIG. 16) and pour liquid 203 into the reservoir section 202 of the hollow, top-most headgear section. A receiver/sensor 202 could be positioned at the front of said top brace to receive a wireless signal 208 from a blaster gun 229 of the system, or from another device of the gameset 200. It can be any wireless signal 208 as described earlier. Inside the structure of the skeletal headgear 201 could be a small power source such as a battery, a printed circuit board, a speaker, etc. as earlier described. “Goggles” 220 could be positioned in front of the eyes of the wearer and the inside of said goggles 220 could contain an electronic display 204 to present an image of the gaming activity to the player/wearer.

Alternatively the front eyewear section 220 could be without any lenses or any display 204, with the player/wearer looking through eye openings, so that a player wearing headgear 201 might sit in front of a computer monitor or other remote screen, or hold in their hand a smartphone 216, and participate in the gaming event. Alternatively, and in this embodiment, there is not even any “eyewear” framing in front of the wearer of headgear 201. The head strap 246 of the headgear 201 could be size adjustable.

FIG. 17 illustrates two (or more) players being enabled to compete in a gaming activity while being situated physically remote one from the next, one player's environment (Player A, seated) and his location being exemplified by a window showing a boat on water, the other player's window showing a mountain-scape. Player B is standing and exemplifies headgear 201 in the form of a wireless headset that can send and receive signals via Bluetooth or Wi-Fi or similar protocol, to a smartphone 228 being held by that same player. The smartphone 228 could then send and receive signals wirelessly via telephone or Wi-Fi or Bluetooth protocols via the internet. His opponent Player A may be seated in front of a computer keyboard 227, playing via keyboard commands or via a joystick or computer mouse 230. The seated player's headset 201 can comprise a permanent or a removably attached electronic display to present an image of the game to the eyes of the player (Player A), or his headgear 201 could have clear goggles so that he could see an image displayed on a computer screen in front of him (not shown). As both Players A and B participate in the digital gaming experience, their responses and action, either physical (body movement) or console/controller-based (described herein as joystick 226 or button or keyboard 227 activated), can influence, direct and affect their gaming status as well whether they might win or lose a competition, at which time liquid release might be activated onto the head of a losing player, from his headgear 201. This kind of activity and technical gaming experience, except for the unique and entertaining penalty of water release, is well known to anyone skilled in the art. In the event players are physically present in the same room or building, they could communicate via the same Wi-Fi router, and not require an internet connection.

FIG. 18 depicts a wearer's view of the screen of an electronic display 204 that might be presented to the wearer of headgear 201. In FIG. 18, the aforementioned wearer, Player A, is not shown. Goggles 220 can include a strap 246. A water reservoir 202 is not shown, but is understood to be coupled to the rest of the headgear 201. A primary image is displayed on the electronic display 204 and said image can change in response to the actions and responses of the player/wearer of the headgear 201, or the actions and responses of other players involved in the gaming experience, or in response to digital programming provided by the software of the digital game. For example, the software can present an image of a forest on the electronic display 204. As the wearer moves around motion sensors in his headgear 201 can signal to the gameset 200 that he is exiting the forest and the electronic display 204 can now present an image of a cityscape. This kind of interactive digital display 204 is well-known to anyone skilled in the art of virtual reality and augmented reality or mixed reality gaming. A second screen 249 (illustrated at the upper right corner of the screen in FIG. 18) could present to the player/wearer of the headgear 201 an actual image of another player/competitor (Player B in FIG. 18) playing the same game. That image 249 could be of an avatar of that other player (Player B), or could be an actual live, transmitted image of Player B, transmitted from a remote digital camera, for example on a laptop computer, of Player B. When that Player B gets water or another liquid 203 released onto his head as a result of the gaming experience as described earlier, the player/wearer of the headset 201 of FIG. 18 could see that occurrence real-time, or could enjoy an image of the avatar of his opponent getting wet.

An avatar is described as: “In computing, an avatar is the graphical representation of the user or the user's alter ego or character. An icon or figure representing a particular person in a video game, Internet forum, etc. It may take either a three-dimensional form, as in games or virtual worlds, or a two-dimensional form as an icon in Internet forums and other online communities. Avatar images have also been referred to as ‘picons’ (personal icons) in the past, though the usage of this term is uncommon now. It can also refer to a text construct found on early systems such as MUDs. The term “avatar” can also refer to the personality connected with the screen name, or handle, of an Internet user”. https://en.wikipedia.org/wiki/Avatar (computing).

FIG. 19 depicts a minimalistic headgear 201 design for the invention. The headgear 201 is basically a set of injection-molded plastic large-framed glasses 220, with the display of images being in the lenses of the glasses 220, the water reservoir 202 being in somewhat larger eyeglass temple pieces, and the electronic componentry as described earlier also being contained, perhaps in the opposite side temple. That would include a small battery, a pc board, etc. As earlier-described in this application, the lens area of the glasses 220 illustrated in this FIG. 19 could be empty or transparent, so that a player (labelled as Player A in FIG. 19) looked through to an electronic display 204 on another device of the gameset 200, or the glasses 220 of this embodiment could simply have a nose-bridge support and not even offer a “lens” area.

FIGS. 20 and 21 depict alternative and more classic gaming consoles that could work with the game system of the invention. A small desktop console 228 could provide a dedicated and non-removable screen, or could provide a bracket or slot to removably receive a smartphone 216 onto the desktop console 228 that would display digital images of the game activity. Player A depicted in FIG. 21 could be wire-connected or else wirelessly communicating with the game system console. The release of liquid 203, preferably water, onto the head of a player of the console in FIG. 20 or 21 would be a result of the play scenarios as earlier described. Buttons and joysticks 226 could be included on the console so that the player could manipulate the images onscreen to try to win the game and cause an opponent to get wet, or to avoid himself getting wet, also as earlier described.

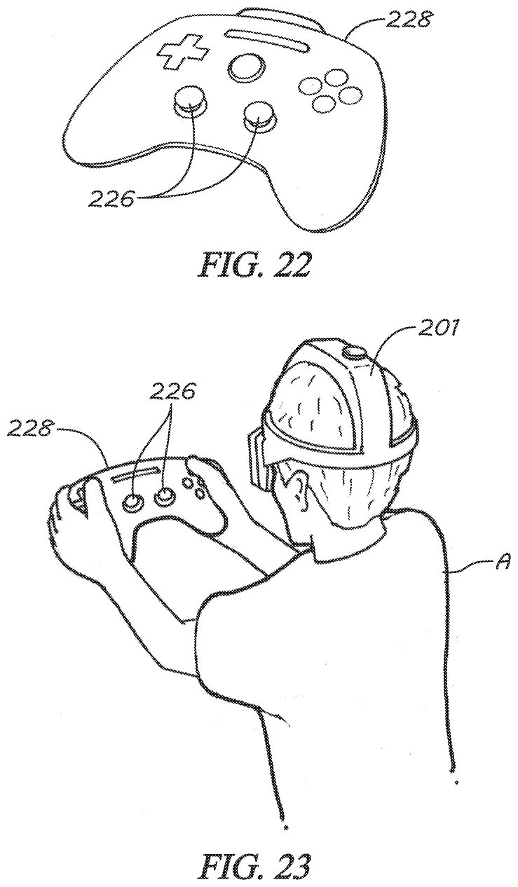

FIGS. 22 and 23 depict similar consoles of the game system that can be manipulated by a player of the system, except these consoles do not provide electronic display 204 and instead simply provide manipulative input for Player A who is wearing headgear 201 of the gameset 200 that provides that player with digital images directly in his line of sight, either by way of a permanent and dedicated electronic display 204, or by way of the coupling of a smartphone 216 to said headgear 201. Buttons or joysticks 226 are provided for Player A. As earlier described, the display 204 is attached to the headgear 201. Formatting and positioning of the screen in the line of sight of Player A could provide for either virtual reality or augmented reality play experiences. See FIGS. 12 and 13.

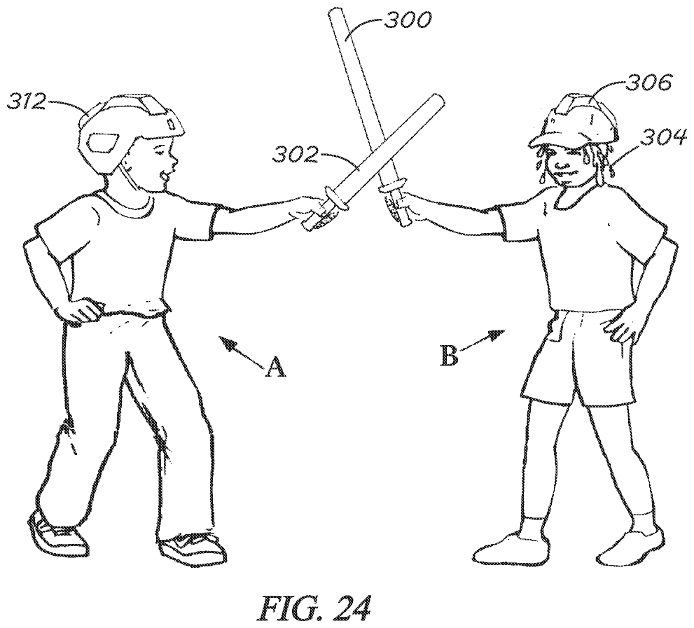

### The Embodiments of FIGS. 24-33 Constituting the New Material Disclosed in this Application

FIGS. 24-33 illustrate further embodiments in which water or another liquid is dispensed onto a player upon activation of a motion and/or impact sensor, which may be located in a toy weapon. The sensor may, in turn, activate transmission of a signal from a transmitter to a receiver coupled to headgear worn by a player. In turn, reception of the signal may cause the release of liquid from a liquid reservoir via one or more exit ports located on headgear onto a player.

More particularly, FIG. 24 illustrates two players (Player A and Player B) of a gameset engaging in role-play make-believe combat, each player holding and manipulating a toy weapon, namely swords 300 and 302 that contains electronic components that can transmit a wireless signal to either their own headgear or the headgear of the other player. In FIG. 24, player B is experiencing the release of water 304 onto the back of his neck as a result of his electronic helmet 306 having received a signal (e.g., a wireless activation signal) from the sword 302 of Player A, said signal having been initiated as a result of Player A having moved his sword in some particular manner, or having struck Player B's own sword 300, and the impact of that strike having activated the transmission of said wireless signal. Alternatively, Player B's sword having received impact from Player A's weapon, Player B's own sword could be programmed to initiate the sending of a wireless signal to activate emission of water onto his own head from his own helmet.

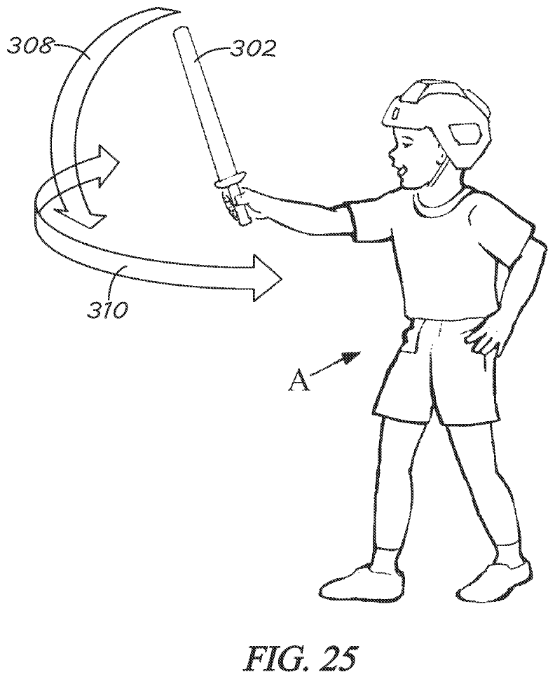

FIG. 25 illustrates certain movements represented by exemplary movement arrows 308 and 310 of the sword 302 by a player A, said sword containing electronic sensors or switches such as a motion sensor (e.g., an accelerometer) or impact sensor (not shown in this figure but understood by one of ordinary skill), can be activated as the result of certain movements by or impacts to said sword 302 so that a wireless signal or signals from said electronics to a remote receiving unit, such as another player's electronic helmet (not shown), can activate water emission onto the head of the player or players (see FIG. 24) who might be wearing said electronic helmet.

A motion sensor is a broad term to encompass several embodiments of electronic components utilized to initiate an electronic action in response to a detection of motion either by sensing movement (such as a tilt sensor) or photoelectric change, or vibration sensing, or change in acceleration from one position to another position. Motion sensors are defined and described in detail online at, for example www.allaboutcircuits.com/technical-articles/an-introduction-to-motion-sensors-pir-tilt-force-and-more/

An accelerometer is defined as follows: “An accelerometer is a tool that measures proper acceleration.[1] Proper acceleration is the acceleration (the rate of change of velocity) of a body in its own instantaneous rest frame; [2] this is different from coordinate acceleration, which is acceleration in a fixed coordinate system.” (en.wikipedia.org/wiki/Accelerometer)

Impact (or shock) sensors are defined as follows: “Shock and impact sensors are used to detect and record shock or impact to a product or package. Shock sensors represent a subtype of inertial sensors, which includes accelerometers and vibration sensors. In fact, accelerometers can be and often are designed to measure shock as well as proper acceleration. Shock and impact sensors are designed to detect instances of sudden impact or severe vibration in order to output a value or, in the case of impact switches, activate or deactivate a circuit or device.” www.globalspec.com/leammore/sensors_transducers_detectors/acceleration_vibration_sensing/shock_impact_sensors

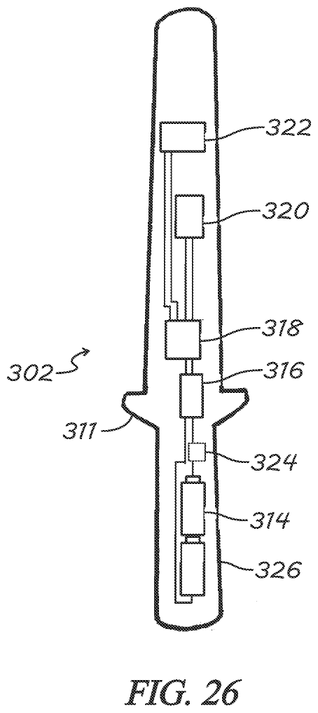

FIG. 26 illustrates exemplary electronic components that can provide for electronic signal transmission after a motion or impact switch/sensor has been activated by motion of or impact to the toylike sword 302 by the player. Such activation as described above, can be the result of the player having moved the toylike weapon in conjunction to a preprogrammed, required path (example: swing left, swing up, turn weapon downward, swing up again), or could be the result of a motion or impact sensor being triggered by contact of the weapon with another weapon, or some other object for example with the body of an opponent. The outer housing of the toylike weapon would preferably be injection or blow molded plastic, such as high impact styrene, or ABS (acrylonitrile butadiene styrene) or polypropylene or other durable material typically employed in the manufacture of toys. The interior of the weapon can contain a power supply such as DC batteries 314, a transmitter 316 to send the wireless signal to a remote receiving device (not shown in FIG. 26), a printed circuit board 318 that can also be preprogrammed to contain “movement requirements” and/or “motion requirements” of the weapon in order for the transmission signal to be initiated. The circuitry could also contain standard components 320 to provide for lights such as LED lights to be illuminated, and for sounds to be emitted, for example from a piezo or similar speaker, at specific times. The lighting and sound parts (LED lights, wiring, speakers, etc.) specifically related thereto are not illustrated but known to all familiar with the art of toy products. A motion or impact sensor 322 would also be included in the electronic circuitry. The weapon may also include a power switch 324 to turn the circuitry on and off. The player could hold the toy weapon by the molded handle area 326. Portions of the toy weapon could be molded foam material such as EPP (expanded polypropylene) instead of injection molded plastic.

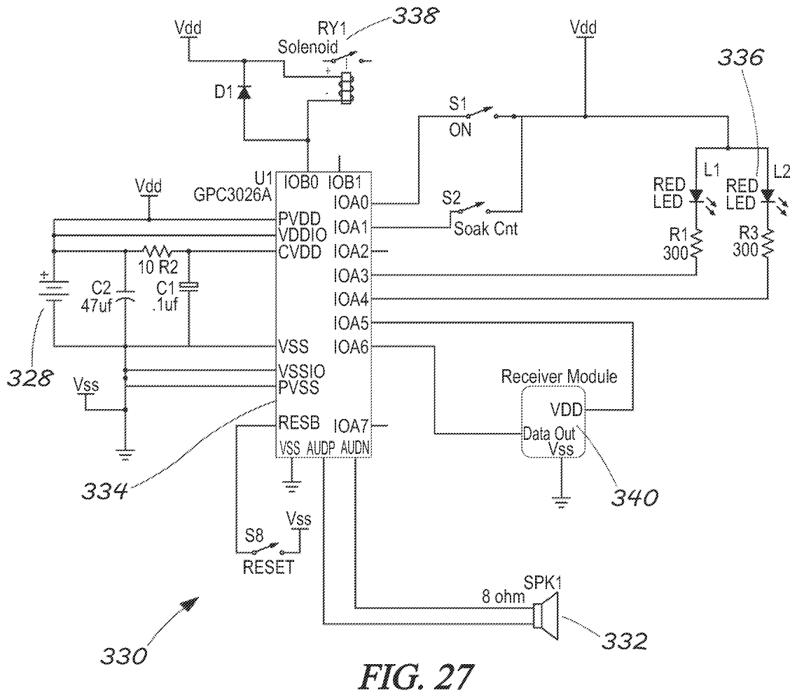

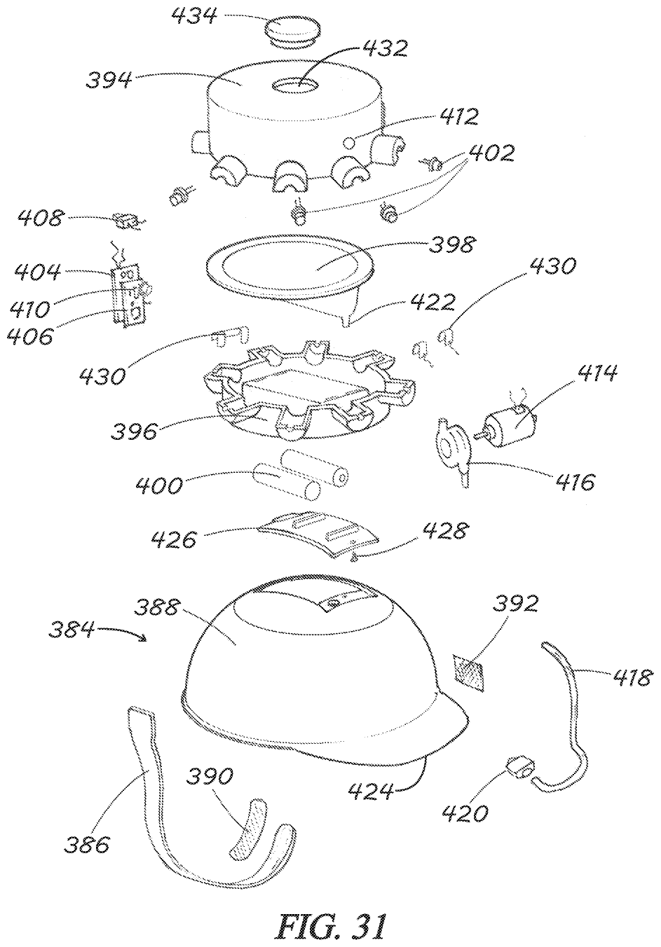

FIG. 27 illustrates an exemplary schematic of the electronic circuitry for the headgear 306 or 312 shown earlier in FIG. 24, understandable by anyone familiar with the art of basic toy electronics. A battery or batteries 328 provides power for the circuitry 330. Said battery or batteries 328 could for example, be alkaline or nickel metal hydride, disposable or rechargeable. Lithium or alkaline batteries could be utilized. Battery technology is commonly known for simple electronic toys. Voltage could preferably be 1.5 to 9 volts, direct current. These battery characteristics are representative of additional battery power sources mentioned in this patent application. Said circuitry 330 is intended to receive a wireless signal when said wireless signal is transmitted from another toy of this gameset, for example sword 302 in FIG. 26 and received by a receiver 340 initiating a series of programmed events in said headgear 312. Preferably the wireless technology utilized by the components of this invention would be Bluetooth or radio signal or infrared signal transmission and reception, it being understood that advances in wireless signal technology can result in new methods of wireless signal transmission and reception that might replace or supersede the current mentioned technologies. Infrared signal is most easily directionally controlled, if that was desired. Otherwise, radio or Bluetooth signal or similar technology would be desired. A speaker 332 could be provided to generate sounds when the circuitry 330 was turned on, activated during a gameplay sequence, or shut off. A circuit board 334 can be programmed to control and provide for gameplay logic, timing, and water release commands, as well as LED light 336 illumination. A solenoid controller 338 can be employed to release water from the water container 354 (FIG. 31). A toy motor 414 (FIG. 31), for example a Mabuchi RE-280RA 6-volt DC motor 46 (FIG. 31) could be employed and activated by circuitry to release water or pump water onto a player's head.

One variant of a motor is often referred to as a bi-metallic switch or bi-metallic strip or even bi-metallic motor. Such a device could be utilized to open and close a valve in the headset to release water. A bi-metallic switch is commonly known to anyone reasonably knowledgeable in toy electronic design, and can be substituted in place of a small standard motor that often includes a rotating shaft to activate gears to accomplish a mechanical function, or solenoid—two components mentioned in this application as well as in the inventor's already cited '340 patent, and other related applications. A bimetallic switch is defined as follows: “A bimetallic switch is a control engineering component which causes a certain action once a defined temperature is reached, e.g., switching off a process in order to avoid overheating. It is based on the fact that under changing thermal conditions every metal expands or contracts according to a fixed thermal expansion coefficient. Hence the bimetal, a component made of two connected strips of different metals (e.g., steel and zinc), bends when the temperature changes. Once the bending strain reaches the limit defined by the designer of the switch, the bimetallic switch is activated.” (www.labom.com/en/glossary/bimetallic-switch.html)

It should be noted that a bi-metallic switch or bi-metallic strip is technically considered a unique motor in its own right.

Bimetallic Thermal Overload Relay: A bimetallic strip is the operating component of a thermal motor overload relay. Thermal overload relays are one of the most common and economical motor overload protection devices, especially for single-phase motors. The third party description above in essence presents the bi-metallic device as a primary motor component.

Also for reference: “A Bimetal strip heat engine” “This toy is based on the simplest, most common object in the house that moves when heat is applied. It is an engine made from a thermometer”. https://sci-toys.com/scitoys/scitoys/thermo/thermo3.html

MIT Engineering assures us that “motor” and “engine” are at this time used interchangeably. engineering.mit.edu/engage/ask-an-engineer/whats-the-difference-between-a-motor-and-an-engine/.

The definition of “Motor” in Merriam Webster Dictionary substantiates this by way of definition: (Entry 1 of 3) 1: one that imparts motion specifically: prime mover. Definition of motor (Entry 2 of 3) 1a: causing or imparting motion b: of, relating to, or being a motor neuron or a nerve containing motor neurons motor fiber c: of, relating to, concerned with, or involving muscular movement motor areas of the brain 2a: equipped with or driven by a motor b: of, relating to, or involving an automobile c: designed for motor vehicles or motorists. www.merriam-webster.com/dictionary/motor

U.S. Pat. Nos. 10,471,340 and 10,950,059, preceding this application and related hereto disclose the display of images to the wearer of a headgear of the invention. U.S. Pat. No. 10,950,059 further discloses such digital image presentation being achieved via a game console, a computer screen or a smartphone display, etc. Such digital image presentation is not necessary for the basic functioning and play of the elements disclosed herein this application, but it should be noted that digital image presentation to increase or improve the game-play experience would work well for the gaming purposes described herein. For example, players could be wearing an augmented or virtual reality headset of the game system already described in the inventor's already issued patents, and look at, or “through” the displayed digital images and meanwhile participate and engage in, for example, sword-play combat with an opponent either standing in close proximity to him, or even presented to him either as the actual opponent or as an avatar figure representing the actual opponent via the image transmission of the game system, as previously described in related applications. It should also be understood that in the event a player of the game system of this invention was not engaged in competition with an actual human competitor but was instead engaged in combat play with an adversary depicted in a programmed video or game system challenge, that fictional adversary also qualifies as the image being presented to the wearer of the headset.

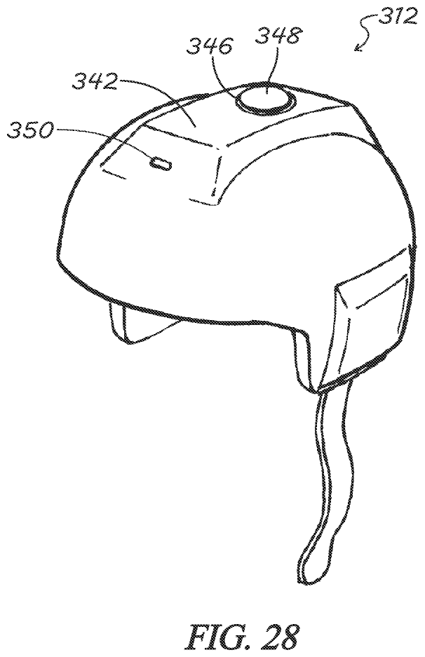

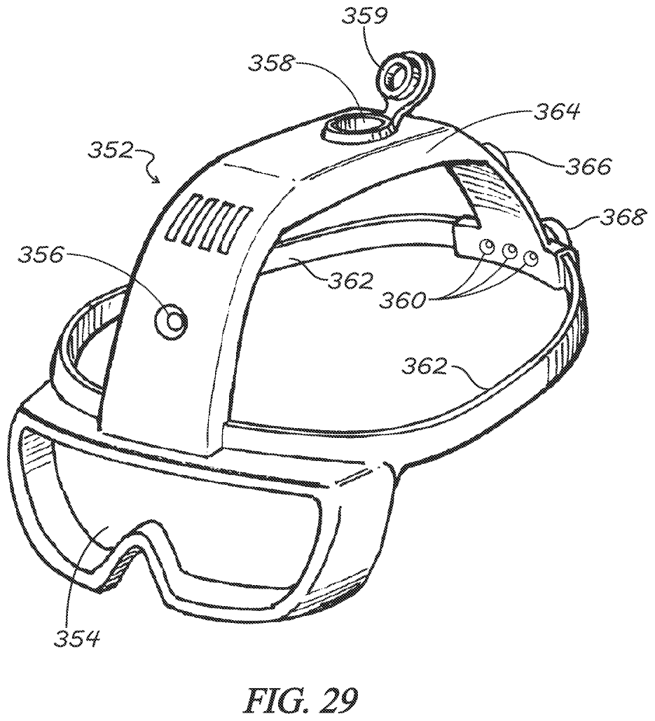

FIG. 28 illustrates an exemplary headgear, in the form of a helmet 312. Also preferably molded of durable plastic, like the weapons, the helmet can contain a water container area 342 with a fill port 346 and cap 348, a sensor 350 to receive the wirelessly transmitted signal, and electronic componentry that will activate the preferably electromechanical release of water from the water container, onto the head of the wearer. It should be noted that the headgear can be any shape and style and in fact could be molded to simulate a helmet worn by a famous action hero, such as Thor or Darth Vader, etc. The headgear can also be minimalistic in its construction as presented in FIG. 29 of this application.

FIG. 29 illustrates a helmet 352 of the game system that is more skeletal in look. The front “googles” could actually provide a transparent plastic goggle “lens” that could be looked through, or could be even without any lens. The electronic sensor 356 would preferably be up front on the helmet, as illustrated. The water fill opening 358 could have a hinged cap 359 to plug the fill hole. The top section 364 of the molded headgear could provide the chamber to contain water or other liquid, to be released during the gameplay. This helmet illustrates several water emission ports 360 that could be positioned at the back of the helmet so that water is emitted, at least in part, onto the back of the neck of the wearer. Liquid release ports (exit ports) can also be located at multiple other locations 362, for example, on the helmet, or limited to specific locations. The helmet could also include componentry for lights and sounds, and even scoring of number of wireless signals received, or water-release activations. The helmet would also have a battery supply to provide power to its electronic components. A simple valve (not shown) such as a diverter to change or restrict the pathway of the liquid could be included in the passageway to the water emission ports, so that a player might have the option to choose which of the exit ports 360 or 362, might emit water or another liquid during a particular gameplay. For example, if a game was being played indoors, near a computer keyboard or near other third party gaming equipment that might become inoperative were it to get wet, then perhaps a player would position said valve by manually turning valve adjustment knob 366 so that liquid only was emitted from rear exit ports 360. Adjustment knob 366 could also be replaced by an electronic button switch powered by the power source inside the headgear.

Other embodiments of this invention are easily imagined and understood. An electronic target board (appearing, for example, like a dartboard) could be mounted on a wall. It could contain the electronic sensor circuitry as earlier described in FIG. 27. Once a player struck or hit a particular section of the target board with a simple projectile, for example striking a “bulls-eye” center area, (striking that target area with a ball or dart or other projectile) an impact sensor in the dartboard, as earlier described herein, located inside the target board, could activate the transmission of a wireless signal to a headgear unit or helmet of the invention, at which time the helmet could receive the wireless signal and then cause the release of water onto the head of a competitor who was wearing said headgear or helmet.

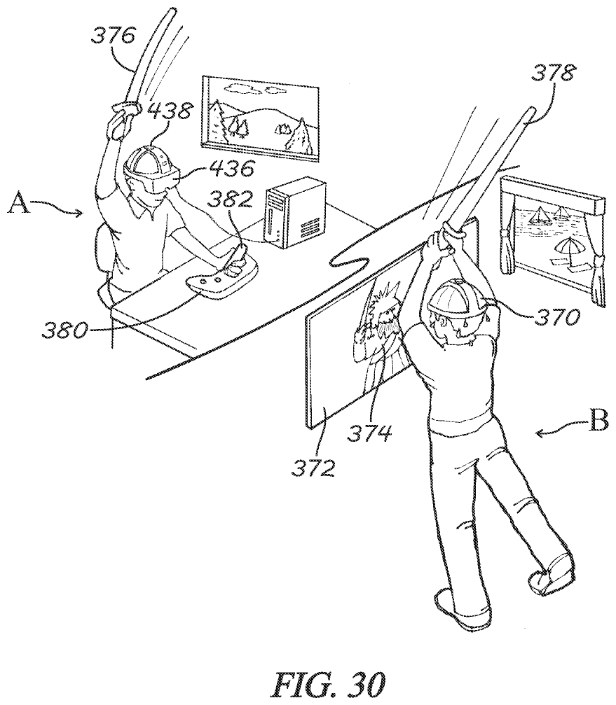

FIG. 30 illustrates two (or even more) players being enabled and empowered by the components of this invention to compete in a gaming activity while being situated physically remote one from the next, one player's environment (Player A, seated) and his location being exemplified by a window showing a mountain-scape, the other player's window (Player B, standing) showing a boat on water. Because of the worldwide presence of internet communications, one player could be at a game system in, for example, Asia, while other players could be playing in Europe or America. In this exemplary illustration, Player B is standing and wears headgear 370 in the form of a molded hat or helmet-like headset that can send and receive signals via Bluetooth or Wi-Fi, Nearfield or similar protocol, either directly to the internet or if necessary to a smartphone (not shown) nearby Player B, or to a signal reception component such as a home wifi modem (also not shown). All such options and means for wireless signal sending and receiving are commonly understood by anyone skilled in the art. Headgear of said invention may include a container to hold a liquid such as water, a fill port, a valve or similar operative orifice that can be opened or closed by means of a motor (e.g., bimetallic strip) or solenoid so that the liquid is retained until the proper time in the gameplay sequence of events and released onto the player at said proper time. All such details have been described elsewhere in this application and in the prior-allowed applications relating hereto.

Player B is standing in front of a large screen 372 that can be a television or a computer flat screen monitor. Shown on the screen of this FIG. 30 is an image of a mighty Viking swordsman 374 who could be the digital avatar of Player A, so that Player B could see Player A's sword 376 movements and try to wield his own sword 378 accordingly to score points or activate release of water onto the head of Player A. Alternative to an avatar image, a camera in front of Player A (not shown, but understood by anyone skilled in the art) could transmit an image of actual Player A onto any digital display screen in the line of sight of Player B. In this illustrated embodiment a liquid is being released onto the back area of Player B's neck, from the headgear worn by Player B. In this illustrated embodiment because Player B is observing an image on a large electronic screen, he does not require a gaming unit such as a console or a computer keyboard, and instead Player B's toylike weapon can send a wireless signal or signals to the internet via a cellphone nearby to which it is communicating, or even directly via wife signal to a household internet modem, for example.

Player B is wielding a toy sword of the gameset (action movements of the sword illustrated by movement lines), said toy sword containing an accelerometer, or motion sensor or similar component as described herein this application. That same sword could also include an impact sensor in the event Player B wanted to play-battle an opponent sword-to-sword, as opposed to remotely.

In this remote-play embodiment, Player A (Player B's opponent) may be seated in front of a computer or a gaming controller 380 capable of sending and receiving wireless signals. The gaming controller can include user-manipulative components such as buttons and/or a joystick or joysticks 382, along with wireless signal sending and receiving capabilities if it were not hard-wired to another component. A desired feature of a special gaming controller for this invention could be its ability to withstand water leaking or invasion into the electronic and mechanical inner parts. Such waterproofing would assure players and purchasers that any water that might be released from headgear of the invention would have no adverse effect on the operation of the game system. Waterproofing of electronic toys and devices is commonly known and proven quite successful over many years of commercialization, with radio controlled boats and even fully submersible submarine toys, www.walmart.com/ip/Mini-RC-Submarine-Electronic-Boat-Ship-Diving-Toy-Waterproof-for-Swimming-Pool-Fish-Tank-Toddlers-Gift/548522082 as well as other pool toys containing batteries, motors and circuitry. Waterproofing is effective and readily achieved by production sealing of typically non-sealed spaces between plastic parts, by gaskets or rubber elements. Such waterproofing can, for example, be between a joystick and the upper housing of the controller unit www.amazon.com/BIN-BON-Waterproof-Momentary-Controller/dp/B07J1Q7PFX, or around a plastic button as it protrudes from a molded housing. Battery compartments could also have a small rubber or vinyl sealing gasket. In the event a participant wanted to utilize a keyboard for play of the described gaming system with its water delivery, keyboards could be similarly waterproofed, or could be covered by a transparent plastic cover such as is used in restaurants or dusty or wet environments. The inclusion of waterproof or water-resistant consoles or other componentry specifically intended for the novel gaming system described in this application provides a significant marketing and sales opportunity since most all other electronic gaming systems componentry offers little advantage to said other gaming systems since most all other gaming systems are never intended or envisioned to be played with in an environment or play pattern specifically intended for the release of water, while such play activity is unique to this invention and its related patents and patent applications. It should be mentioned that the release of water from headgear of the invention could also be directed to only dispense from holes at the rear of headgear if so desired. A switch (either electronic or manual) on the headgear could control whether water release was from every direction, or only from holes at the rear of the headgear.

It should be noted that in this embodiment standing Player B is looking at a digital image displayed on screen 372, while the seated player's (player A's) headset can comprise a permanent or a removably attached electronic display screen to present an image of the game directly to the eyes of the player, for example as successfully enjoyed in augmented or virtual reality gaming play. As both Players A and B participate in the digital gaming experience, their responses and action, either physical (body movements, in this embodiment moving and wielding the play sword) or console/controller-based (described herein as joystick 382 or button or keyboard activated), can influence, direct and affect their gaming status as well whether they might win or lose a competition, at which time (in the case of winning) liquid release might be activated onto the head of a losing player, from his headgear, regardless as to how remote the opponent was located. This kind of remote wireless long-distance digital gaming activity is commonly known, with the significant exception of the novel and highly-entertaining penalty of water release which is described and disclosed in this application and related prior applications related hereto. In the event players are physically present in the same room or building, they could also either (a.) communicate via the same Wi-Fi router, and not require an internet connection; or (b.) the componentry of the game system of this invention could be manufactured to communicate directly one with another.

FIG. 31 illustrates an exploded view of exemplary headgear 384 of the invention. Strap 386 can secure said headgear main housing 388 onto a player's head, by securing around their chin via hook and loop fastener material 390 and 392, or a snap or buckle. Alternatively, an adjustable flexibly molded inner sizing ring (not shown) could be installed into the main housing 388 and then adjusted for head size fit. A top container may be generally comprised of top section 394 to hold water or another liquid and bottom section 396. Bottom section 396 would not contain water in this embodiment but instead could be isolated from the water area by a reservoir bottom 398. A housing for liquid could also be a flexible bladder, such as a latex balloon, etc. The top section would provide a fill hole 432 and a removable cap 434 to seal said fill hole. Within bottom section 396 could be the electronic and electro-mechanical components of the headgear 384, such as batteries 400, LED's 402, an ON/OFF switch circuit board 404, signal receiver circuit board 406, etc. Coupled to said ON/OFF switch circuit board 404 may be ON/OFF switch 408 that is accessible by the wearer from the outer surface of the helmet 384, and also wireless beam receiver 410, which is controlled by a receiver module, which could receive a wireless signal from a remote wireless signal transmitter earlier described. In addition to a helmet, the player may also wear goggles 436 (as shown in FIG. 30). In the event the wireless signal transmission was infrared and required line-of-sight, access portal 412 could be so molded as to directionally provide desired line of sight signal transmission reception. When the ON/OFF switch circuit board 404 is activated, (in a preferred embodiment) a small motor 414 of any design, such as a coil wound motor, or bi-metallic strip motor, or solenoid could activate either the opening of a hinged gate-like doorway to allow water to flow downward onto the head of the wearer, or a pump 416 could draw water from the top reservoir housing 394 and then spray that water through a molded passageway or tube 418 and a spray tip nozzle 420 or nozzles via exit ports described elsewhere in this application, onto the wearer of the headgear. Proximal end of tube 418 could be molded abutting or coupled to the bottom of reservoir bottom outlet 422. Distal end of tube 418 may be attached to the underside of headgear brim 424. Batteries 400, battery door 426, battery door screw 428, and contacts 430 are all commonly understood parts and not described in detail. In the event rechargeable batteries were to be employed, recharging could be via a recharger port, not shown but commonly understood. It is also commonly understood that batteries require contacts to complete their connection to the components utilizing their power, and therefore not illustrated.

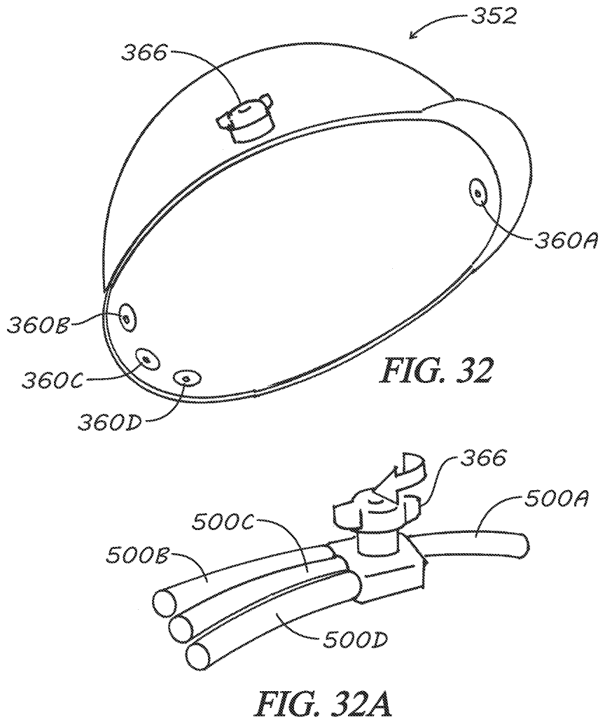

FIG. 32 illustrates the underside of exemplary headgear 352 of the gameset, with four exit ports 360A-360D for liquid to be released onto the head of a wearer. One port 360A is positioned inside the headgear near the front brim. Three ports 360B, 360C and 360D are positioned towards the back of the headgear, so that water from those ports 360B, 360C and 360D would wet the back of the player's neck. Such arrangement is exemplary and that any number of ports could be positioned anywhere in the headgear. The player-controlled simple valve with knob 366 is depicted on the outside of the headgear.

FIG. 32A is representative of an enlarged and generalized image of the diverter valve and its diverting capabilities to four different “tubes” that functionally could even be water passageways in-molded into the structure of the headgear 352. In one position the three ports 360B, 360C and 360D at the back of the headgear would be operative to emit water once a signal activated to cause water release from the water reservoir described elsewhere in this application. When the valve knob 366 was rotated into another position, the molded inner shape of the valve would shut off flow of water into the three rear ports 360B, 360C and 360D and instead direct all of the water flow to exit from the front port 360A. Similar rotating valve controls are employed with garden hoses sharing a common spigot. Electronic diverter valves could be operated by solenoids or small motors, but would be more costly. In FIG. 32A, tubes leading to exit ports 360B, 360C and 360D are labelled 500B, 500C and 500D, respectively and the tube leading to exit port 360A is labelled 500A.

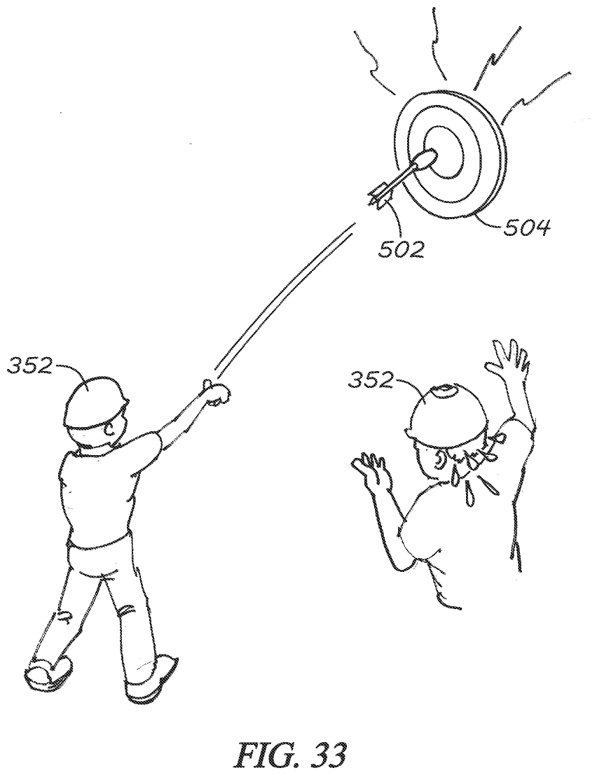

FIG. 33 depicts an embodiment in which a toy projectile 502, for example a safe toy dart or safe toy arrow, is thrown or otherwise propelled toward a target board 504. Electronic circuitry as described elsewhere in this application could be mounted inside the target unit, behind the graphic target circles. Such electronics could include an impact sensor (e.g., small microswitches that could be triggered upon impact of specific areas), batteries, and on/off switch, a small circuit board with capabilities to transmit a signal or signals to another toy of the game system, such as a headgear with a receiver and water reservoir. The microswitches could be activated, or impact sensor in the dartboard could detect impact, when the projectile struck specific locations, and such impact could activate the sending of a wireless signal to the headgear of a player, activating the release of water or other liquid onto the head of the wearer. Alternatively, the electronics could be inside the projectile 502, as described in earlier FIGS. 24 and 25, in which case no electronics would be required inside the target. When the projectile struck the target or any hard object, it, like the sword of FIGS. 24 and 25, could send a signal to headgear to cause release of water.

While certain exemplary embodiments have been described and shown in the accompanying drawings, it is to be understood that such embodiments are merely illustrative of and not intended to be restrictive on the broad invention, and that this invention not be limited to the specific construction and arrangements shown and described herein, since various modifications may occur to those ordinarily skilled in the art.

Having now described the invention in accordance with the requirements of the patent statutes, those skilled in the art will understand how to make changes and modifications to the disclosed embodiments to meet their specific requirements or conditions. Changes and modifications may be made without departing from the scope and spirit of the invention. In addition, the steps of any method described herein may be performed in any suitable order and steps may be performed simultaneously if needed.

It is not the intent of this patent application to describe or claim a specific display means by which a game system can display an electronic image to a player or players of the invention. Instead it is the expressed intent of the invention disclosed and described herein, by way of example and references to already-known display componentry and embodiments, for example virtual reality and augmented reality displays as well as computer-monitor and smartphone or electronic tablet displays, to provide an entertaining and highly visual “pay-off” event involving the release of a liquid, preferably water, onto the head or heads of players as a result of competitive outcome of digital gaming challenges. Future advances in the technical display of digital images can also benefit from the liquid release event as a result of digital gaming experiences as generally disclosed herein.

Terms of degree such as “generally”, “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

REFERENCE NUMERALS

| NUMBER | DESCRIPTION |
|---|---|
| 1 | player one |
| 2 | player two |
| 3 | Playhat |
| 4 | toy blaster gun |
| 5 | signal beam |
| 6 | electronic signal receiver |
| 7 | water (released) |
| 8 | container |
| 9 | removable cap |
| 10 | retainer strap |
| 11 | water tube |
| 12 | target area |
| 13 | LED |
| 14 | playhat ON switch |
| 15 | trigger |
| 16 | front tip |
| 17 | blaster gun ON switch |
| 18 | hat brim |
| 19 | nozzle |
| 20 | hat cavity |
| 21 | mechanical valve assembly |
| 24 | seated player 01 |
| 25 | seated player 02 |
| 26 | seated player 03 |
| 27 | console |
| 28 | seated player 01 hand |
| 29 | player 01 console button |
| 30 | player 02 console button |
| 31 | player 03 console button |
| 32 | player 04 console button |
| 33 | seated player 25 hand |
| 34 | game table 34 |
| 35 | console ON button |
| 36 | water spray from console |
| 37 | plastic rods |
| 38 | nozzle (console) |
| 39 | turret (console) |
| 40 | playhat circuitry |
| 41 | battery |
| 42 | speaker |
| 43 | circuit board (hat) |
| 44 | LED’s |
| 45 | solenoid controller on circuit board |
| 46 | motor |
| 47 | pump |
| 48 | blaster gun circuitry |
| 49 | circuit board (gun) |
| 50 | beam transmitter |
| 51 | signal receiver |
| 52 | hat strap |
| 53 | water container top section |
| 54 | water container bottom section |
| 55 | reservoir bottom |
| 58 | blaster gun housing half |
| 59 | blaster gun housing half |
| 60 | batteries (gun) |
| 61 | electronic circuitry schematic for console |
| 62 | speaker |
| 63 | Console LED lights |
| 64 | Console transmitter |
| 65 | Console circuit board |
| 66 | Console housing top |
| 67 | Console housing bottom |
| 68 | Console Game button switch |
| 69 | Console button switches |
| 70 | console battery door |
| 72 | Console master ON/OFF switch |
| 73 | Console wireless signal transmitter |
| 74 | Console batteries |
| 75 | Console battery contacts |
| 76 | Console integrated circuit board |
| 77 | Console battery door screw |
| 78 | playhat loop fastener strip |
| 79 | playhat hook fastener strip |
| 80 | playhat wireless signal access portal |
| 81 | playhat water tube |
| 82 | playhat solenoid |
| 83 | playhat reservoir bottom water coupling |
| 85 | playhat pivoting valve plate |
| 86 | playhat battery door |
| 87 | playhat battery door screw |
| 88 | playhat battery contacts |
| 89 | playhat reservoir bottom hole |
| 90 | playhat flexible seal |
| 91 | playhat target area sidewall. |
| 92 | blaster gun circuitry trigger switch |
| 93 | console speaker |
| 100 | transmitter |
| 101 | handle |
| 200 | Gameset |
| 201 | Headgear |
| 202 | Liquid reservoir |
| 203 | Liquid |
| 204 | Electronic display/Electronic display screen |
| 205 | Receiver |
| 206 | Remote device |
| 207 | Transmitter |
| 208 | Signal |
| 211 | Image |
| 213 | Exit port |
| 216 | Mobile phone |
| 217 | Camera |
| 219 | Transparent or semi-transparent plate |
| 220 | Eyewear |
| 223 | Motion or attitude sensor or accelerometer |
| 226 | Joystick |
| 227 | Keyboard |
| 226 | Controller Unit |
| 229 | Toy blaster gun |
| 230 | Computer mouse |
| 231 | Trigger |
| 232 | Handle |
| 234 | Computer |
| 237 | Valve |
| 243 | Fill port |
| 245 | Bracket |
| 246 | Strap |
| 249 | Second screen |
| 300 | Sword |
| 302 | Sword |
| 304 | Water |
| 306 | Headgear |
| 308 | Movement arrows |
| 310 | Movement arrows |
| 311 | Outer housing of toylike weapon |
| 312 | Headgear |
| 314 | DC batteries |
| 316 | Transmitter |
| 318 | Printed circuit board |
| 320 | Components |
| 322 | Motion or impact sensor |
| 324 | Power switch |
| 326 | Molded handle area |
| 328 | Battery or batteries |
| 330 | Circuitry |
| 332 | Speaker |
| 334 | Circuit board |
| 336 | LED light |
| 338 | Solenoid controller |
| 340 | Receiver |
| 342 | Water container area |
| 346 | Fill port |
| 348 | Cap |
| 350 | Sensor |
| 352 | Helmet |
| 354 | Liquid reservoir |
| 356 | Electronic sensor |
| 358 | Water fill opening |
| 359 | Hinged cap |
| 360 A-D | Water emission ports |
| 362 | Liquid release ports at other locations |
| 364 | Top section |
| 366 | Valve adjustment knob |
| 370 | Headgear |
| 372 | Screen |
| 374 | Image |
| 376 | Sword |
| 378 | Sword |
| 380 | Controller |
| 382 | Buttons or joysticks |
| 384 | Helmet |
| 386 | Strap |
| 388 | Main housing |
| 390 | Hook and loop fastener or snap or buckle |
| 392 | Hook and loop fastener or snap or buckle |
| 394 | Top section |
| 396 | Bottom section |
| 398 | Reservoir bottom |
| 400 | Batteries |
| 402 | LEDs |
| 404 | ON/OFF Switch circuit board |
| 406 | Signal receiver circuit board |
| 408 | ON/OFF switch |
| 410 | Wireless beam receiver |
| 412 | Access portal |
| 414 | Motor |
| 416 | Pump |
| 418 | Passageway or tube |
| 420 | Spray tip nozzle |
| 422 | Reservoir bottom outlet |
| 424 | Headgear brim |
| 426 | Battery door |
| 428 | Battery door screw |
| 430 | Contacts |
| 432 | Fill hole |
| 434 | Removable cap |
| 436 | Goggles |
| 500 | Tubes (500 A-D) |
| 502 | Toy projectile |
| 504 | Target board |

What is claimed is:

1. A gameset configured to emit a liquid onto a player comprising:
headgear configured to be worn on a head of a player and comprising a liquid reservoir configured to hold a liquid;
a receiver coupled to the headgear;
a motion sensor and/or an impact sensor, and a transmitter to transmit a signal to the receiver upon reception of a signal from the motion sensor and/or the impact sensor; and
one or more power sources configured to power the transmitter, the motion sensor and/or the impact sensor and the receiver,
wherein, upon reception of the signal from the transmitter, the receiver is configured to activate dispensing of liquid from the liquid reservoir onto the player.

2. The gameset of claim 1 wherein the gameset comprises at least two toy weapons and at least two headgear, each headgear configured to be worn by a player, coupled to a receiver and comprising a liquid reservoir, each toy weapon comprising a transmitter and a motion sensor and/or an impact sensor.

3. The gameset of claim 2 wherein each transmitter is in electronic communication with a receiver.

4. The gameset of claim 1 wherein the gameset further comprises a wearable and/or toy weapon comprising said motion sensor and/or impact sensor.

5. The gameset of claim 1 wherein the gameset further comprises a wearable comprising said motion sensor and/or impact sensor and said wearable is a bracelet, body armor, or belt.

6. The gameset of claim 1 wherein the gameset further comprises a toy weapon comprising said motion sensor and/or impact sensor and said toy weapon is a sword, club, hatchet, cudgel or shield.

7. The gameset of claim 6 wherein the toy weapon comprises at least a motion sensor, and said motion sensor is an accelerometer.

8. The gameset of claim 1 wherein the headgear further comprises a valve to release liquid from said liquid reservoir, said valve controlled by a solenoid or by a motor.

9. The gameset of claim 8 wherein said valve is controlled by a bi-metallic switch.

10. The gameset of claim 1 wherein the gameset further comprises an electronic display screen.

11. The gameset of claim 10 wherein the electronic display screen is a television monitor or computer monitor.

12. The gameset of claim 10 wherein the electronic display screen is located on a mobile phone, said mobile phone also comprising a microphone, a processor, and a speaker.

13. The gameset of claim 1 wherein the one or more power sources comprises a first power source configured to power the transmitter and a second power source configured to power the receiver.

14. The gameset of claim 1 wherein the toy weapon comprises one or more buttons or switches configured to be activated by one or more players.

15. The gameset of claim 1 wherein upon reception of the signal from the transmitter, the receiver is configured to cause liquid from the liquid reservoir to be dispensed downward onto the player, said dispensing aided and not hindered by gravity.

16. The gameset of claim 1 wherein the headgear further comprises a fill hole and a cap for sealing the fill hole.

17. The gameset of claim 1 wherein the headgear further comprises one or more exit ports configured to dispense liquid from the liquid reservoir onto the player.

18. The gameset of claim 17 wherein the headgear comprises a plurality of exit ports to dispense liquid located in the reservoir onto the player, wherein dispensing of liquid through the exit ports is regulated by at least one diverter valve, and further wherein the gameset comprises a controller to selectively operator the at least one diverter valve.

19. The gameset of claim 18 wherein at least one of the exit ports is configured to dispense water onto the back of the neck of the player.

20. The gameset of claim 1 further comprising a game controller comprising a waterproof housing.

21. The gameset of claim 20 wherein the waterproof housing comprises silicone and/or one or more gaskets.

22. The gameset of claim 1 wherein the gameset further comprises a toy weapon comprising said motion sensor and/or impact sensor and said toy weapon further comprises a light configured to illuminate the toy weapon.

23. A method of play involving one or more players comprising the steps of:
a) providing the gameset of claim 1, wherein the gameset further comprises a wearable and/or a toy weapon comprising said motion sensor and/or impact sensor;
b) placing the headgear on at least one player's head;
c) moving a toy weapon and/or wearable;
d) sensing movement and/or impact of the toy weapon and/or wearable using the motion sensor and/or the impact sensor;
e) transmitting a signal from the transmitter to the receiver; and
f) dispensing liquid from the liquid reservoir onto at least one player wearing the headgear in response to the receiver coupled to such player receiving the signal.

24. The method of claim 23 wherein the gameset further comprises an electronic display screen and further wherein the method further comprises displaying imagery on the electronic display screen.

25. The method of claim 23 wherein step f) comprises dispensing liquid from the liquid reservoir onto the back of the neck of the player wearing the headgear.

26. A method of play involving two or more players comprising the steps of:
a) providing the gameset of claim 1, wherein the gameset comprises at least two headgear, each headgear configured to be worn by a player, coupled to a receiver and comprising a liquid reservoir, and at least two toy weapons, each toy weapon comprising a transmitter and a motion sensor and/or an impact sensor;
b) placing the headgear on a plurality of players' heads;
c) holding a respective toy weapon in a first player's hand;
d) sensing movement and/or impact of the respective toy weapon using the respective toy weapon's motion sensor and/or impact sensor;
e) transmitting a signal from the transmitter of the respective toy weapon to the receiver coupled to a second player; and
f) dispensing liquid from the liquid reservoir onto the second player in response to the receiver coupled to such player receiving the signal.

27. The method of claim 26 wherein the method further comprises at least two toy weapons of each player contacting each other prior to step d), step d) comprising sensing said contact using the respective toy weapon's impact sensor.

28. A gameset configured to emit a liquid onto at least one player comprising:
a) headgear configured to be worn on a head of a player or players, at least one of such headgear comprising a liquid reservoir configured to hold a liquid;
b) a receiver coupled to said headgear;
c) a waterproof game controller comprising a transmitter to transmit a signal to said receiver; and
d) one or more power sources configured to power the transmitter and the receiver,
wherein, upon reception of the signal from the transmitter, the receiver is configured to activate dispensing of liquid from the liquid reservoir onto a player.

29. The gameset of claim 28 wherein the gameset further comprises an electronic display screen.

30. The gameset of claim 28 wherein the gameset further comprises a motion sensor and/or an impact sensor.

31. A gameset configured to emit a liquid onto a player comprising:
headgear configured to be worn on a head of a player and comprising a liquid reservoir configured to hold a liquid;
a receiver coupled to the headgear;
a toy weapon;
a target towards which said toy weapon can be projected or thrown, said target comprising a motion sensor and/or an impact sensor, and a transmitter to transmit a signal to the receiver upon reception of a signal from the motion sensor and/or the impact sensor; and
one or more power sources configured to power the transmitter, the motion sensor or the impact sensor and the receiver,
wherein, upon reception of the signal from the transmitter, the receiver is configured to activate dispensing of liquid from the liquid reservoir onto the player.

32. The gameset of claim 31 wherein the target is a dartboard.

33. The gameset of claim 31 wherein said toy weapon is a projectile.
